(19) United States
(12) Patent Application Publication
(10) Pub. No.: US 2025/0026871 A1
(43) Pub. Date: Jan. 23, 2025

(54) CYCLIC RUTHENIUM BENZYLIDENE INITIATORS FOR ENHANCED RING EXPANSION METATHESIS POLYMERIZATION

(71) Applicants: University of Washington, Seattle, WA (US); Massachusetts Institute of Technology (M.I.T.), Cambridge, MA (US)

(72) Inventors: Matthew Golder, Seattle, WA (US); Teng-Wei Wang, Seattle, WA (US); Jeremiah A. Johnson, Seattle, WA (US)

(73) Assignees: University of Washington, Seattle, WA (US); Massachusetts Institute of Technology, Cambridge, MA (US)

(21) Appl. No.: 18/553,976

(22) PCT Filed: Apr. 4, 2022
(86) PCT No.: PCT/US2022/023353

§ 371 Date: Oct. 4, 2023

Related U.S. Application Data
(60) Provisional application No. 63/171,474, filed on Apr. 6, 2021.

(51) Int. Cl. C08F 132/04; C07F 15/00

(52) U.S. Cl. CPC C08F 132/04; C07F 15/0046

(57) ABSTRACT

Cyclic ruthenium benzylidene initiators useful for the controlled synthesis of functionalized cyclic macromolecules via ring-expansion metathesis polymerization.

### CROSS-REFERENCE TO RELATED APPLICATION

This application claims the benefit of U.S. Application No. 63/171,474, filed Apr. 6, 2021, expressly incorporated herein by reference in its entirety

### BACKGROUND

Cyclic polymers are promising building blocks for novel organic materials; their “endless” hoop-like architectures display drastically different behaviors in solution and the solid-state compared to their linear counterparts. Their smaller hydrodynamic radii and lack of chain ends contribute to unique thermal and physical properties; applications spanning biomaterials, energy and sustainability provide the impetus to develop new methodologies for their preparation.

Most synthetic examples involve acyclic ring-closures or ring-expansion polymerizations (REP) account for most synthetic examples. With advanced synthetic applications in mind, the latter is arguably more convenient as the cyclic initiator facilitates both monomer insertion and templated ring-closure. Despite myriad REP reaction classes, ring-expansion metathesis polymerization (REMP) remains one of the most versatile ways to access cyclic macromolecules. For acyclic polymers, advances in W, Mo, and Ru ring-opening metathesis polymerization (ROMP) initiator design have allowed for widespread adoption of this valuable methodology. W and Mo initiators are quite active and desirable for certain applications, but often initiators are derived from more air and functional group tolerant ruthenium N-heterocyclic carbene (NHC) complexes, such as Grubbs 2^{nd} (G2) and 3^{rd} (G3) generation scaffolds (FIG. 1A). A sterically demanding NHC imparts stability, while a bulky benzylidene ensures facile ligand dissociation.

For cyclic polymers, W and Mo metathesis initiators can facilitate REMP of both alkene and alkyne monomers, but examples are largely limited to hydrocarbon feedstocks.

Despite the overwhelming success of Ru ROMP initiators, the Ru REMP initiators developed by Fürstner and Grubbs have never been optimized to the same extent as G2 and G3 (FIG. 1B, UC5 and SC5). Therefore, a need exists for a tunable cyclic Ru-NHC platform for REMP that improves upon the current poor molecular weight control, limited stability, and slow polymerizations. The present invention seeks to fulfill this need and provides further advantages.

### SUMMARY

In one aspect, the disclosure provides ruthenium compounds useful for initiating ring-expansion polymerization reactions. In certain embodiments, the ruthenium compounds have Formula (I):

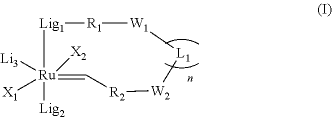

wherein:
X₁ and X₂ are each independently halo;
Lig₁ is an unsaturated N-heterocyclic carbene comprising 1, 2, 3, or 4 N atoms, wherein said unsaturated N-heterocyclic carbene is optionally substituted with 1, 2, or 3 substituents each independently selected from halo, aryl, heteroaryl, C₁₋₆ alkyl, and C₁₋₆ haloalkyl, wherein said aryl, heteroaryl, C₁₋₆ alkyl, and C₁₋₆ haloalkyl are further each optionally substituted with 1, 2, 3, or 4 substituents each independently selected from halo, C₁₋₆ alkyl, and C₁₋₆ haloalkyl; or
Lig₁ is a moiety of Formula (A-1):

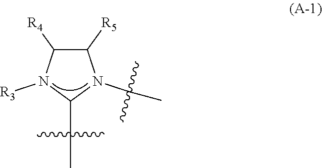

wherein:
R₃ is selected from aryl and heteroaryl, each optionally substituted with 1, 2, 3, or 4 substituents each independently selected from halo, C₁₋₆ alkyl, and C₁₋₆ haloalkyl; and
R₄ and R₅ are each independently selected from H, C₁₋₃ alkyl, halo, C₁₋₃ haloalkyl, aryl, and heteroaryl;
Lig₂ is selected from a phosphine and heteroaryl, each optionally substituted with 1, 2, 3, or 4 substituents each independently selected from halo, C₁₋₆ alkyl, C₁₋₆ haloalkyl, cycloalkyl, and aryl;
Lig₃ is selected from absent and heteroaryl, wherein the heteroaryl is optionally substituted with 1, 2, 3, or 4 substituents each independently selected from halo, C₁₋₆ alkyl, C₁₋₆ haloalkyl, cycloalkyl, and aryl;
R₁ is selected from C₁₋₁₂ alkylene, arylene, and heteroarylene, each optionally substituted with 1, 2, 3, or 4 substituents each independently selected from halo, C₁₋₆ alkyl, and C₁₋₆ haloalkyl;
R₂ is selected from arylene and heteroarylene, each optionally substituted with 1, 2, 3, or 4 substituents each independently selected from halo, C₁₋₆ alkyl, and C₁₋₆ haloalkyl;
W₁ and W₂ are each independently selected from O, C(R₆′)(R₇′), S, and N(R₆″), wherein R₆′, R₇′, and R₆″ are each independently selected from H, halo, C₁₋₆ alkyl, and C₁₋₆ haloalkyl;
L₁, at each occurrence, is selected from C(R₆)(R₇), arylene, and heteroarylene, wherein said R₆ and R₇ are each independently selected from H, halo, C₁₋₃ alkyl, aryl, and heteroaryl; and wherein said arylene and heteroarylene are each optionally substituted with 1, 2, 3, or 4 substituents each independently selected from halo, C₁₋₆ alkyl, and C₁₋₆ haloalkyl; and
n is an integer selected from 3 to 24.

In another aspect, the present disclosure provides a method for using a cyclic ruthenium compound to initiate a ring-expansion polymerization reaction. In certain embodiments, the method comprises combining, to provide a reaction mixture, a cyclic olefin monomer with an effective amount of a ruthenium compound as described herein having a cyclic group of a pre-determined size, whereby the cyclic olefin monomer successively inserts into the cyclic group to increase the size thereof in a stepwise manner without detachment of any linear species from the complex, and following completion of polymerization on the ruthenium compound, the cyclic polymer is released from the compound by an intramolecular chain transfer reaction.

Methods for making the cyclic ruthenium compounds are also disclosed.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings.

FIGS. 1A-1C compare the structural features of a ruthenium ROMP initiator (1A), a ruthenium REMP initiator (1B), and a representative cyclic ruthenium benzylidene initiator (CB6) of the disclosure (1C).

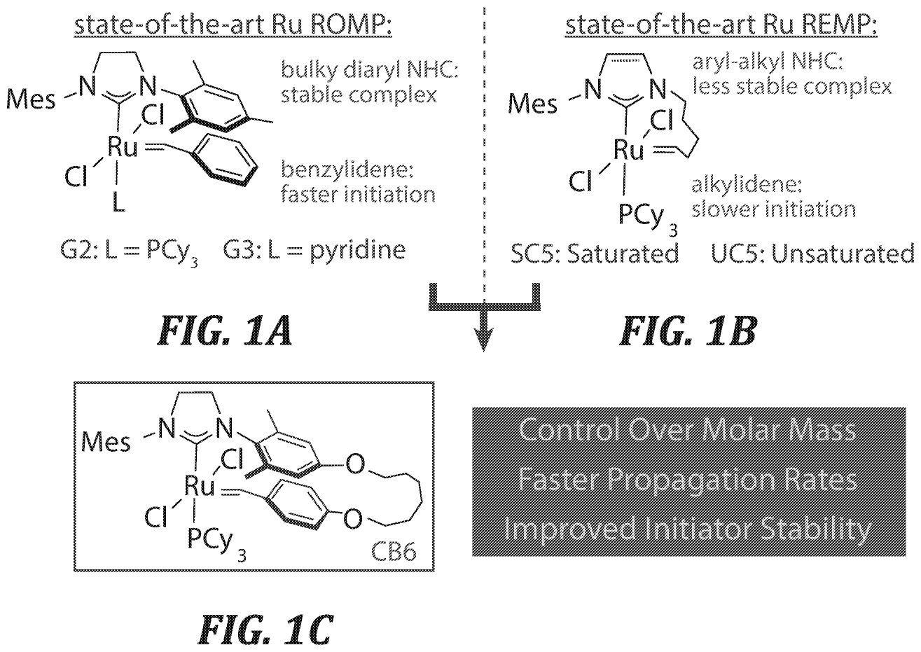

FIG. 2 is a schematic illustration of the REMP mechanism depicting initiation (i), propagation (ii), and uncontrolled ring-closure (iii).

FIGS. 3A and 3B compare the log (molar mass) versus retention time plot (3A) and Mark-Houwink-Sakurada plot obtained for REMP and ROMP of AcNb (3B). GPC-MALS-IV data were collected in CHCl₃ at 35° C.

FIGS. 4A and 4B compare AcNb monomer consumption ([AcNb]₀=1 mM, [I:AcNb]=1:50) monitored by ¹H NMR spectroscopy (55° C. in DCE-d4) (4A) and the Mark-Houwink-Sakurada plot obtained during REMP of AcNb with CB6 in the presence of 3-hexene (4B).

FIG. 5 compares the stability of initiators G2, UC5, and CB6 in deuterated benzene (C₆D₆) recorded over time using ¹H NMR spectroscopy (internal standard: naphthalene). Conditions: [initiator]₀=0.018M in 500 μL of C₆D₆, sample prepared and sealed in a nitrogen-filled glovebox.

FIG. 6 compares the evolution of GPC traces during REMP of AcNb with CB6 at various [CB6:AcNb] ratio. REMP condition: [monomer]₀=0.2 M, 55° C.

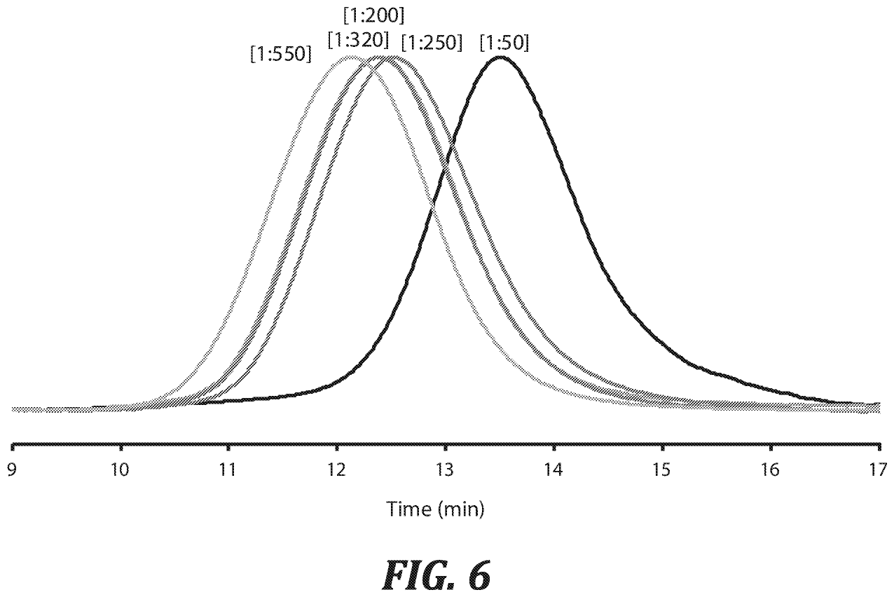

FIG. 7 compares the evolution of GPC traces during REMP of BnNb with CB6 at various [CB6:BnNb] ratio. REMP condition: [monomer]₀=0.2 M, 55° C.

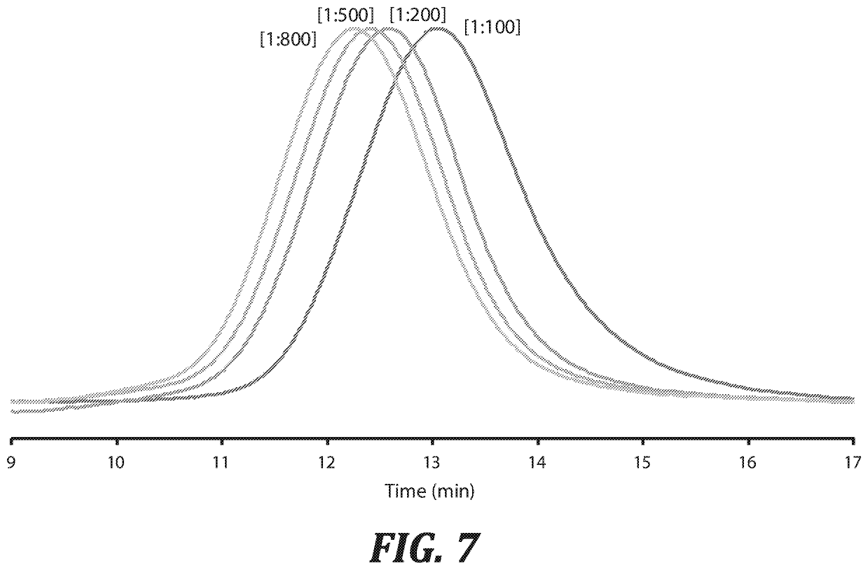

FIG. 8 illustrates M_{w} and (Ð=M_{w}/Mₙ) profiles versus [CB6:BnNb] of the monomer in living AcNb REMP.

FIG. 9 illustrates M_{w} and (Ð=M_{w}/Mₙ) profiles versus [CB6:BnNb] of the monomer in living BnNb REMP.

FIG. 10 illustrates a GPC trace (RI) of benchtop REMP of AcNb with CB6 in air. M_{w}: 583 kDa, Mₙ: 388 kDa, M_{w}/Mₙ: 1.50. REMP condition: [CB6:AcNb]=1:200, [monomer]₀=0.2 M, 55° C. for 12 hr.

FIG. 11 illustrates the evolution of M_{w} with time as assessed by GPC-MALS-IV. REMP conditions: [CB6:AcNb]=1:200, [monomer]₀=0.2 M, 55° C.

FIG. 12 illustrates the evolution of M_{w} with time as assessed by GPC-MALS-IV. REMP conditions: [CB6:BnNb]=1:200, [monomer]₀=0.2 M, 55° C.

FIG. 13 illustrates the Mark-Houwink-Sakurada plot obtained during REMP of AcNb with G2 in the presence of varying concentrations of 3-hexene CTA. [CTA]:[Ru]32 0:1→10:1. Data point marked with arrow indicates data when no CTA was added (i.e., [CTA]:[Ru]=0:1).

FIG. 14 illustrates the Mark-Houwink-Sakurada plot obtained during REMP of AcNb with UC5 in the presence of varying concentrations of 3-hexene CTA. [CTA]:[Ru]=0:1→10:1. Data point marked with arrow indicates data when no CTA was added (i.e., [CTA]:[Ru]=0:1).

FIG. 15 is a schematic illustration of a representative ruthenium compound of the invention (CB6) and its X-ray crystal structure.

### DETAILED DESCRIPTION

The present disclosure provides cyclic ruthenium-benzylidene compounds useful as initiators for ring-expansion metathesis polymerization (REMP) reactions with cyclic olefins to provide cyclic macromolecules.

In one aspect, the disclosure provides ruthenium compounds useful as REMP reaction initiator compounds. The ruthenium compounds disclosed herein are cyclic ruthenium N-heterocyclic carbene (NHC) complexes. Referring to Formula (I) below, N-heterocyclic carbene Lig₁ is indirectly linked to the arylene or heteroarylene functionality R₂ through a linkage (R₁—W₁—(L₁)ₙ—W₂). By virtue of this linkage of Lig₁ to R₂, the ruthenium compounds are cyclic; effectively, Lig₁ is tethered to R₂. As used herein, the terms “compound” and “complex” are used interchangeably when describing the ruthenium initiators disclosed herein.

In certain embodiments, the ruthenium compound has Formula (I):

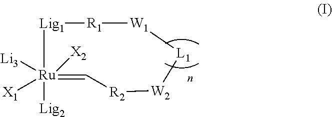

wherein:
X₁ and X₂ are each independently halo;
Lig₁ is an unsaturated N-heterocyclic carbene comprising 1, 2, 3, or 4 N atoms, wherein said unsaturated N-heterocyclic carbene is optionally substituted with 1, 2, or 3 substituents each independently selected from halo, aryl, heteroaryl, C₁₋₆ alkyl, and C₁₋₆ haloalkyl, wherein said aryl, heteroaryl, C₁₋₆ alkyl, and C₁₋₆ haloalkyl are further each optionally substituted with 1, 2, 3, or 4 substituents each independently selected from halo, C₁₋₆ alkyl, and C₁₋₆ haloalkyl; or
Lig₁ is a moiety of Formula (A-1):

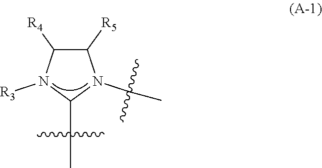

wherein:
R₃ is selected from aryl and heteroaryl, each optionally substituted with 1, 2, 3, or 4 substituents each independently selected from halo, C₁₋₆ alkyl, and C₁₋₆ haloalkyl; and
R₄ and R₅ are each independently selected from H, C₁₋₃ alkyl, halo, C₁₋₃ haloalkyl, aryl, and heteroaryl;
Lig₂ is selected from a phosphine and heteroaryl, each optionally substituted with 1, 2, 3, or 4 substituents each independently selected from halo, C₁₋₆ alkyl, C₁₋₆ haloalkyl, cycloalkyl, and aryl;
Lig₃ is selected from absent and heteroaryl, wherein the heteroaryl is optionally substituted with 1, 2, 3, or 4 substituents each independently selected from halo, C₁₋₆ alkyl, C₁₋₆ haloalkyl, cycloalkyl, and aryl;
R₁ is selected from C₁₋₁₂ alkylene, arylene, and heteroarylene, each optionally substituted with 1, 2, 3, or 4 substituents each independently selected from halo, C₁₋₆ alkyl, and C₁₋₆ haloalkyl;
R₂ is selected from arylene and heteroarylene, each optionally substituted with 1, 2, 3, or 4 substituents each independently selected from halo, C₁₋₆ alkyl, and C₁₋₆ haloalkyl;
W₁ and W₂ are each independently selected from O, C (R₆′)(R₇′), S, and N(R₆″), wherein R₆′, R₇′, and R₆″ are each independently selected from H, halo, C₁₋₆ alkyl, and C₁₋₆ haloalkyl;
L₁, at each occurrence, is selected from C(R₆)(R₇), arylene, and heteroarylene, wherein said R₆ and R₇ are each independently selected from H, halo, C₁₋₃ alkyl, aryl, and heteroaryl; and wherein said arylene and heteroarylene are each optionally substituted with 1, 2, 3, or 4 substituents each independently selected from halo, C₁₋₆ alkyl, and C₁₋₆ haloalkyl; and
n is an integer selected from 3 to 24.

Referring to Formula (I), X₁ and X₂ are discrete anionic ligands, and may be the same or different, or are linked together to form a cyclic group and thus a bidentate ligand, typically although not necessarily a five-to eight-membered ring. In certain embodiments, X₁ and X₂ are each independently halide (e.g., F, Cl, Br, or I). In certain embodiments, X₁ and X₂ are each independently selected from I, Br, Cl, and F. In other embodiments, X₁ and X₂ are each independently Br or Cl. In further embodiments, X₁ and X₂ are each Cl.

Referring to Formula (I), R₁ and R₂ are independently selected from arylene and heteroarylene groups.

As used herein, the term “arylene” refers to a linking aryl group. For example, the term “phenylene” refers to a linking phenyl group (e.g., 1,4-phenylene). Suitable aryl groups include aromatic hydrocarbon groups having 6 to 10 carbon atoms. In some embodiments, the term “aryl” includes monocyclic or polycyclic (e.g., having 2, 3, or 4 fused rings) aromatic hydrocarbons such as, for example, phenyl, naphthyl, anthracenyl, phenanthrenyl, indanyl, and indenyl. The aryl and arylene groups may be further substituted with one or more substituents as described herein (e.g., optionally substituted with 1, 2, 3, or 4 substituents each independently selected from halo, C₁₋₆ alkyl, C₁₋₆ haloalkyl, cycloalkyl, and aryl).

Representative aryl groups include phenyl groups. In certain embodiments, the arylene is a phenylene group, such as 1,4-phenylene group. In certain of these embodiments, the phenyl or phenylene group is optionally substituted with 1, 2, 3, or 4 substituents each independently selected from halo, C₁₋₆ alkyl, C₁₋₆ haloalkyl (e.g., methyl groups).

In certain embodiments, the phenyl group is a 2,4,6-trimethylphenyl (mesityl) group (e.g., CB6 Lig₁). In certain embodiments, the phenylene group is an unsubstituted 1,4-phenylene group (e.g., CB6 R₂). In other embodiments, the phenylene group is a substituted 1,4-phenylene group, such as 2,6-dimethyl-1,4-phenylene (mesitylene) (e.g., CB6 R₁).

As used herein, the term “heteroarylene” refers to a linking heteroaryl group. Suitable heteroaryl groups include 5- to 10-membered aromatic monocyclic or bicyclic ring containing 1-4 heteroatoms selected from O, S, and N. Representative 5- or 6-membered aromatic monocyclic ring groups include pyridine, pyrimidine, pyridazine, furan, thiophene, thiazole, oxazole, and isooxazole. Representative 9- or 10-membered aromatic bicyclic ring groups include benzofuran, benzothiophene, indole, pyranopyrrole, benzopyran, quinoline, benzocyclohexyl, and naphthyridine.

In certain embodiments, the heteroaryl is pyridine or bromo-pyridine and the heteroary lene is pyridinyl or bromo-pyridinyl.

Referring to Formula (I), in certain embodiments, Lig₁ is an unsaturated N-heterocyclic carbene comprising 2 or 3 nitrogen atoms, wherein said unsaturated N-heterocyclic carbene is optionally substituted with 1, 2, or 3 halo, aryl, heteroaryl, C₁₋₆ alkyl, and C₁₋₆ haloalkyl.

In certain embodiments, Lig₁ is a moiety of Formula (A-2)

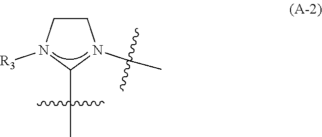

wherein R₃ is selected from aryl and heteroaryl, each optionally substituted with 1, 2, 3, or 4 substituents each independently selected from halo, and C₁₋₆ alkyl. In certain of these embodiments, R₃ is aryl optionally substituted with 1, 2, 3, or 4 substituents each independently selected from halo and C₁₋₆ alkyl. In other embodiments, R₃ is phenyl optionally substituted with 1, 2, 3, or 4 substituents each independently selected from halo and C₁₋₆ alkyl. In further embodiments, R₃ is phenyl substituted with 1, 2, 3, or 4 substituents each independently selected from C₁₋₆ alkyl. In certain of these embodiments, R₃ is

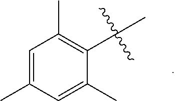

In certain embodiments, L₁, at each occurrence, is selected from C(R₆)(R₇) and arylene, wherein said R₆ and R₇ are each independently selected from H, halo, and C₁₋₃ alkyl; and wherein said arylene is optionally substituted with 1, 2, 3, or 4 substituents each independently selected from halo and C₁₋₆ alkyl. In certain of these embodiments, L₁, at each occurrence, is selected from C(R₆)(R₇), wherein R₆ and R₇ are each independently selected from H and halo. In certain embodiments, L₁ is CH₂.

Lig₂ and Lig₃ are neutral electron donor ligands.

In certain embodiments, Lig₂ and Lig₃ are heteroaryl ligands. Suitable heteroaryl ligands include aromatic nitrogen-containing and oxygen-containing heteroaryl ligands. Representative heteroaryl ligands include monocyclic N-heteroaryl ligands that are optionally substituted with 1 to 3, preferably 1 or 2, substituents. Specific examples of heteroaryl ligands are pyridine and substituted pyridines, such as 3-bromopyridine, 4-bromopyridine, 3,5-dibromopyridine, 2,4,6-tribromopyridine, 2,6-dibromopyridine, 3-chloropyridine, 4-chloropyridine, 3,5-dichloropyridine, 2,4,6-trichloropyridine, 2,6-dichloropyridine, 4-iodopyridine, 3,5-diiodopyridine, 3,5-dibromo-4-methylpyridine, 3,5-dichloro-4-methylpyridine, 3,5-dimethyl-4-bromopyridine, 3,5-dimethylpyridine, 4-methylpyridine, 3,5-diisopropylpyridine, 2,4,6-trimethylpyridine, 2,4,6-triisopropylpyridine, 4-(tert-butyl) pyridine, 4-phenylpyridine, 3,5-diphenylpyridine, 3,5-dichloro-4-phenylpyridine, and the like.

In certain embodiments, Lig₂ is a phosphine of the formula PR₁R₂R₃, where R₁, R₂, and R₃ are each independently aryl or C.1-C10 alkyl, particularly primary alkyl, secondary alkyl, or cycloalkyl. In certain embodiments, Lig₂ is tricyclohexylphosphine, tricyclopentylphosphine, triisopropylphosphine, triphenylphosphine, diphenylmethylphosphine, or phenyldimethylphosphine, with tricyclohexylphosphine and tricyclopentylphosphine preferred.

In certain embodiments, Lig₃ is absent.

In certain embodiments, Lig₂ and Lig₃ are independent selected from pyridine (or pyridyl) and bromo-pyridine (or bromo-pyridyl). In certain embodiments, Lig₂ and Lig₃ are the same.

In certain embodiments, Lig₂ is selected from P(R₈)₃, each R₈ is independently selected from cycloalkyl, heterocycloalkyl; or wherein Lig₂ is pyridyl. In certain of these embodiments,
Lig₂ is selected from P(Cy₃) and pyridyl.

In certain embodiments, Lig₃ is heteroaryl, optionally substituted with 1, 2, 3, or 4 substituents each independently selected from halo and C₁₋₆ alkyl. In certain of these embodiments, Lig₃ is pyridyl.

In certain embodiments, R₁ is selected from C₁₋₁₂ alkylene, arylene, and heteroarylene, each optionally substituted with 1, 2, 3, or 4 substituents each independently selected from halo and C₁₋₆ alkyl. In certain of these embodiments, R₁ is selected from C₁₋₁₂ alkylene and arylene, each optionally substituted with 1, 2, 3, or 4 substituents each independently selected from halo and C₁₋₆ alkyl. In certain of these embodiments, R₁ is C₁₋₁₂ alkylene, optionally substituted with 1, 2, 3, or 4 substituents each independently selected from halo and C₁₋₆ alkyl.

In certain embodiments, R₂ is selected from arylene and heteroarylene, each optionally substituted with 1, 2, 3, or 4 substituents each independently selected from halo and C₁₋₆ alkyl. In certain of these embodiments, R₂ is arylene optionally substituted with 1, 2, 3, or 4 substituents each independently selected from halo and C₁₋₆ alkyl.

In certain embodiments, R₁ is arylene optionally substituted with 1 or 2 C₁₋₆ alkyl; and R₂ is arylene. In certain of these embodiments, R₁ is phenylene optionally substituted with 1 or 2 C₁₋₆ alkyl; and R₂ is phenylene.

In certain embodiments, W₁ and W₂ are each independently selected from O, S, and N(R₆″), wherein and R₆″ is selected from H, halo, and C₁₋₃ alkyl. In certain of these embodiments, W₁ and W₂ are each independently selected from O and S. In certain of these embodiments, W₁ and W₂ are each O.

In certain embodiments, n is an integer selected from 5, 6, and 7. In certain embodiments, n is 6.

In one embodiment, the compound of Formula (I) is

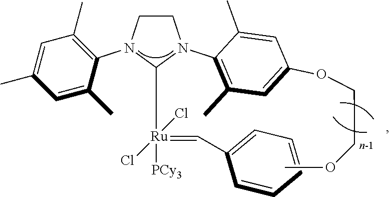

wherein n is 6.

In another embodiment, the compound of Formula (I) is

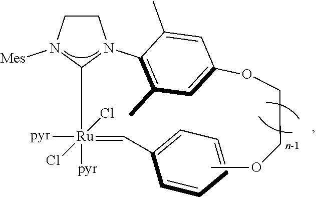

wherein Mes is mesityl and n is 6.

In certain embodiments, the disclosure provides a compound of Formula (I):

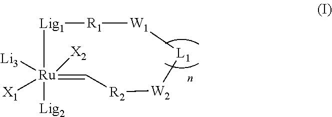

wherein:
X₁ and X₂ are each independently halo;
Lig₁ is a moiety of Formula (A-1):

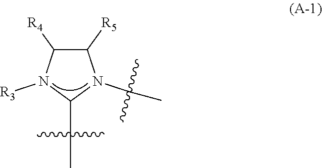

wherein:
R₃ is selected from aryl and heteroaryl, each optionally substituted with 1, 2, 3, or 4 substituents each independently selected from halo, C₁₋₆ alkyl, and C₁₋₆ haloalkyl; and
R₄ and R₅ are each independently selected from H, C₁₋₃ alkyl, halo, and C₁₋₃ haloalkyl;
Lig₂ is selected from a phosphine and heteroaryl, wherein the heteroaryl is optionally substituted with 1, 2, 3, or 4 substituents each independently selected from halo, C₁₋₆ alkyl, and C₁₋₆ haloalkyl;
Lig₃ is selected from absent and heteroaryl, wherein the heteroaryl is optionally substituted with 1, 2, 3, or 4 substituents each independently selected from halo, C₁₋₆ alkyl, and C₁₋₆ haloalkyl;
R₁ is arylene, optionally substituted with 1, 2, 3, or 4 substituents each independently selected from halo, C₁₋₆ alkyl, and C₁₋₆ haloalkyl;
R₂ is arylene, optionally substituted with 1, 2, 3, or 4 substituents each independently selected from halo, C₁₋₆ alkyl, and C₁₋₆ haloalkyl;
W₁ and W₂ are O;
L₁, at each occurrence, is selected from C(R₆)(R₇), wherein said R₆ and R₇ are each independently selected from H, halo, C₁₋₃ alkyl; and
n is an integer selected from 3 to 24.

In other embodiments, the disclosure provides a compound of Formula (I):

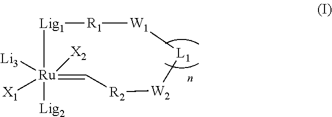

wherein:
X₁ and X₂ are each independently halo;
Lig₁ is a moiety of Formula (A-1):

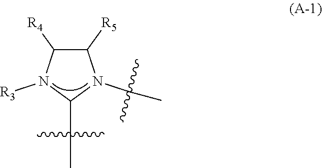

wherein:
R₃ is aryl, each optionally substituted with 1, 2, 3, or 4 substituents each independently selected from C₁₋₆ alkyl; and
R₄ and R₅ are H;
Lig₂ is a phosphine;
Lig₃ is absent;
R₁ is phenylene, optionally substituted with 1 or 2 C₁₋₆ alkyl groups;
R₂ is phenylene;
W₁ and W₂ are O;
L₁, at each occurrence, is CH₂; and
n is an integer selected from 3 to 10.

In further embodiments, the disclosure provides a compound of Formula (I):

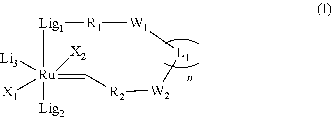

wherein:
X₁ and X₂ are each Cl;
Lig₁ is a moiety of Formula (A-1):

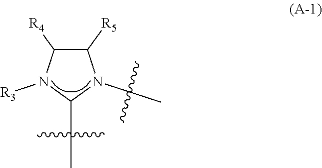

wherein:
R₃ is phenyl, substituted with 1, 2, 3, or 4 substituents each independently selected from C₁₋₆ alkyl (e.g., methyl groups); and
R₄ and R₅ are H;
Lig₂ is a phosphine (e.g., tricyclohexylphosphine);
Lig₃ is absent;
R₁ is 1,4-phenylene, optionally substituted with 1 or 2 methyl groups;
R₂ is 1,4-phenylene;
W₁ and W₂ are O;
L₁, at each occurrence, is CH₂; and
n is an integer selected from 3 to 8 (e.g., 6).

In still other embodiments, the disclosure provides a compound of Formula (I):

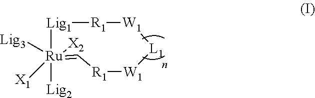

wherein:
X₁ and X₂ are each Cl;
Lig₁ is a moiety of Formula (A-1):

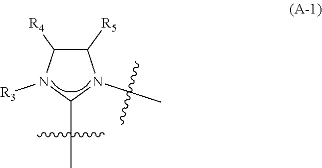

wherein:
R₃ is phenyl, substituted with 1, 2, 3, or 4 substituents each independently selected from C₁₋₆ alkyl (e.g., 3 methyl groups); and
R₄ and R₅ are H;
Lig₂ is heteroaryl (e.g., pyridine);
Lig₃ is heteroaryl (e.g., pyridine);
R₁ is 1,4-phenylene, optionally substituted with 1 or 2 methyl groups;
R₂ is 1,4-phenylene;
W₁ and W₂ are O;
L₁, at each occurrence, is CH₂; and
n is an integer selected from 3 to 8 (e.g., 6).

The ruthenium compounds described herein are chemically stable (i.e., do not decompose) and/or remain chemically active (i.e., functions as a REMP initiator) when stored in a solid form at −20° C. for at least 3 months (e.g., at least 4 months, at least 5 months, or at least 6 months) under inert atmosphere (i.e., N₂ or Argon) at 1 atm.

In another aspect, the present disclosure provides a method for using a cyclic ruthenium compound (e.g., a cyclic ruthenium benzylidine compound) to initiate a ring-expansion polymerization reaction that results in a macrocyclic polymer. The method involves combining, in a reaction mixture, a cyclic olefin monomer with an effective amount of a cyclic ruthenium compound as described herein having a cyclic group of pre-determined size, whereby the cyclic olefin monomer successively inserts into the cyclic group to increase the size thereof in a stepwise manner without detachment of any linear species from the compound. That is, the cyclic polymer grows in cyclic form while attached to the ruthenium compound and the reaction does not involve generation of any linear intermediates. Following completion of polymerization on the ruthenium compound, the cyclic polymer is released from the compound by an intramolecular chain transfer reaction.

In certain embodiments, the method comprises combining, to provide a reaction mixture, a cyclic olefin monomer with an effective amount of a ruthenium compound as described herein having a cyclic group of a pre-determined size, whereby the cyclic olefin monomer successively inserts into the cyclic group to increase the size thereof in a stepwise manner without detachment of any linear species from the complex, and following completion of polymerization on the ruthenium compound, the cyclic polymer is released from the compound by an intramolecular chain transfer reaction.

Examples of cyclic olefin monomer include monounsaturated, monocyclic olefins such as, without limitation, cyclopentene, cyclohexene, cycloheptene, cyclooctene, cyclononene, cyclodecene, cycloundecene, cyclododecene, tricyclodecene, tetracyclodecene, octacyclodecene, and cycloeicosene, and substituted versions thereof such as 1-methylcyclopentene, 1-ethylcyclopentene, 1-isopropylcyclohexene, 1-chloropentene, 1-fluorocyclopentene, 1-methylcyclopentene, 4-methoxy-cyclopentene, 4-ethoxy-cyclopentene, cyclopent-3-ene-thiol, cyclopent-3-ene, 4-methylsulfanyl-cyclopentene, 3-methylcyclohexene, 1-methylcyclooctene, and 1,5-dimethylcyclooctene.

Cyclic olefin monomers useful with the present methodology are unsubstituted monoolefins, particularly low-strain unsubstituted cis-monoolefins such as cis-cyclopentene, cis-cycloheptene, cis-cyclooctene, cis-cyclononene, cis-cyclodecene, cis-cycloundecene, and cis-cyclododecene.

It should also be noted that macrocyclic copolymers produced using the ruthenium inititators described herein can be prepared using two or more different cyclic olefin monomers in the polymerization reaction.

In certain embodiments, the disclosure provides methods for making cyclic polymer. In certain of these embodiments, a cyclic polymer is prepared from a monomer having a carbon-carbon double bond by initiating a ring-expansion metathesis polymerization with a ruthenium compound as described herein. In certain embodiments, the monomer having a carbon-carbon double bond is a norbornene monomer.

In certain embodiments of the method, the ring-expansion metathesis polymerization initiated with a ruthenium compound as described herein occurs at a faster rate compared to a UC5 initiated polymerization using the same monomer.

In certain embodiments of the method, the ring-expansion metathesis polymerization initiated with a ruthenium compound as described herein provides a polymer having narrower molecular weight distribution (as analyzed by gel permeation chromatography) compared to the molecular weight distribution obtained with a UC5 initiator using the same monomer.

The following is a description of the preparation and use of representative ruthenium compounds (e.g., CB6) as initiators for ring-expansion metathesis polymerization reactions.

As described herein, the present disclosure provides a stable cyclic benzylidene initiator, CB6, that facilitates rapid polymerizations and improved molar mass control compared to the state-of-the-art.

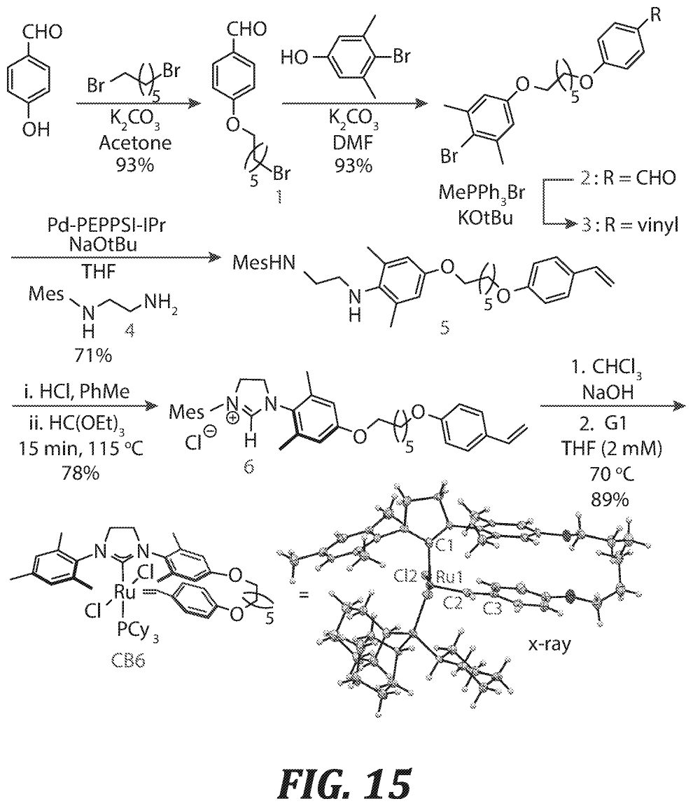

The synthesis of representative cyclic initiator CB6 (see Example 1 and FIG. 15) commences with nearly quantitative alkylation of 4-hydroxy benzaldehyde (1) and 4-bromo-3,5-dimethylphenol with dibromohexane over two steps (2). Subsequent Wittig olefination, followed by PdBrettPhosG3-mediated amination (Bruno, N. C.; Tudge, T.; Buchwald, S. L. Design and Preparation of New Palladium Precatalysts for C—C and C—N Cross-Coupling Reactions. Chem. Sci. 2013, 916-920. https://doi.org/10.1039/c2sc20903a) of aryl bromide 3 with 4 afforded 5 in 70% overall yield. Formation of the requisite diaryl imidazolium salt 6 could be accomplished in one flask (HCl then triethyl orthoformate) in high yield. Deprotonation with sodium hydroxide in chloroform led to protected NHC-adduct that could be cyclized upon addition of Grubbs 1^{st} generation catalyst (G1) (Dias, E. L.; Nguyen, S. B. T.; Grubbs, R. H. Well-Defined Ruthenium Olefin Metathesis Catalysts: Mechanism and Activity. J. Am. Chem. Soc. 1997, 119, 3887-3897. https://doi.org/10.1021/ja963136z) in THF (2 mM) at 70° C. Target CB6 was isolated in 89% yield.

The structure of CB6 was first evaluated using solution-state NMR spectroscopy; a single benzylidene ¹H resonance at δ=19.4 ppm and phosphine ³¹P resonance at δ=28.7 ppm confirmed the presence of a lone organometallic species. The benzylidene resonances appear as singlets for both G2 and CB6, suggesting that the corresponding phenyl rings are nearly orthogonal to the PCy₃ ligand and thus have a negligible ³J_{P-H} value. Cyclic alkylidene complexes SC5 and UC5, on the other hand, adopt geometries that orient the alkylidene hydrogens away from orthogonality (³J_{P-H}≈5-10 Hz) in solution. Additional information was gleaned through solid-state X-ray analysis of CB6 crystals (FIG. 15). Several stark differences exist between dihedral angles in CB6 compared to those of G2 and representative cyclic alkylidene complexes SC5 and UC5. For example, the dihedral angle (φ) outlined by Cl2—Ru—C2—C3 places the phenyl ring of G2 off center from the chlorides by about 12°, while the alkyl chains emanating from the Ru center in SC5 and UC5 are offset by about 20°. Remarkably, the benzylidene ring in CB6 (FIG. 15) is almost coplanar with the chloride ligands (φ=0.08°). Further evidence for the structural rigidity of CB6 is revealed through density functional theory (DFT) calculations conducted at the B3LYP/6-31G(d)//LANL2DZ level of theory. CB6 has 15 kcal/mol of strain energy as assessed by homodesmotic reactions compared to the more flexible alkyl-linked UC5 complex with just 6 kcal/mol of strain energy.

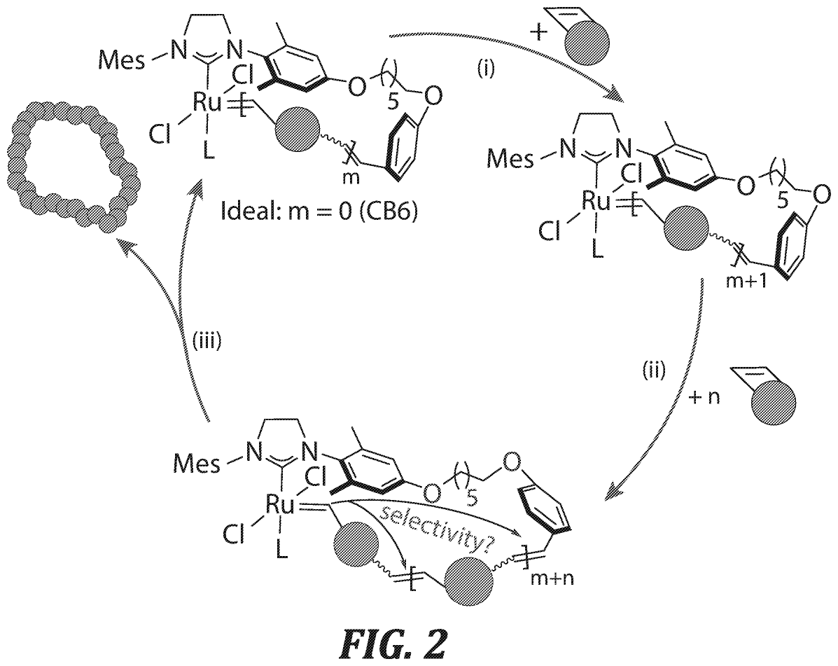

The activity of initiator (I) CB6 was investigated in REMP using two substituted norbornene-imide (Nb) monomers (M): AcNb and BnNb (see Table 1). Despite ROMP polymers derived from Nb finding broad utility in drug delivery, imaging, self-assembly, and photonic applications, these monomer structures have been historically challenging for REMP. Only Ru initiators (i.e., UC5) have been utilized, and in these specific cases, uncontrolled growth of high-molecular weight macrocycles was observed. Polymerizations were initiated (See FIG. 2, i) with CB6 by addition to monomers in DCE. Reactions were stirred under nitrogen at 55° C.; the elevated temperature, previously shown to facilitate chain-transfer in poly (norbornene)s, was employed to promote back-biting for ring formation (See FIG. 2, iii).

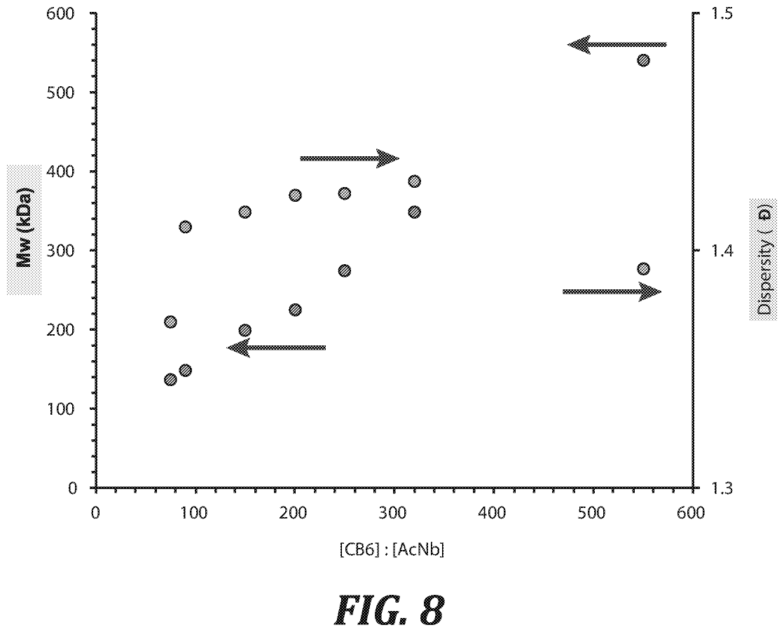

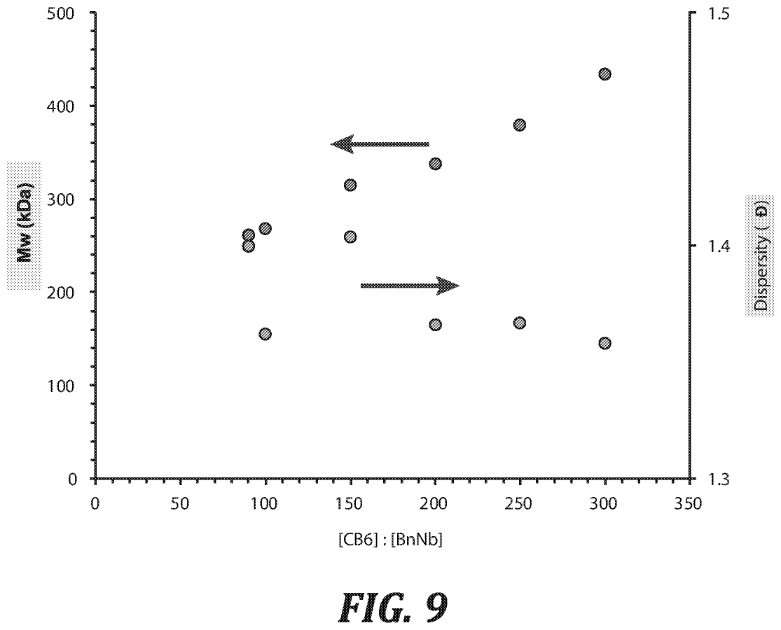

Ideally CB6 is regenerated upon release of cyclic polymer (m=0), but in actuality the ring-closure step is not well controlled and a variety of sizes are produced. Evaluation of a variety of [CB6:M]₀ ratios revealed an increase in absolute weight-average molecular weight (M_{w}) with increased monomer loading (Table 1) as would be expected for a living polymerization. Back-biting kinetics and chain-transfer equilibria likely lead to the observed non-ideal, albeit living, relationships between M_{w} and [M]₀ (see FIGS. 8 and 9). Neither monomer Lewis basicity nor steric encumbrance affected the activity of CB6 significantly. To compare against the current state-of-the-art, analogous REMP reactions initiated with UC5 were performed. Although saturated variants (i.e., SC5) are known to be more active than unsaturated variants, the former is a capricious complex (sufficient quantities of pure SC5 were not obtainable). Hence, the comparison was made with the more widely adopted unsaturated UC5. Previous accounts of Ru-REMP with Nb monomers led to high molecular weight products; consistent results were obtained in a direct comparison of polymers produced from CB6 with those produced from UC5 (Table 1). Polymerizations initiated by CB6 are more controlled and afford molar masses closer to theoretical values, suggesting improved initiator efficiency. These differences may be due in part to stark differences in kinetics (vide infra), and clearly demonstrate a significant advantage of CB6 over UC5 as a REMP initiator.

TABLE 1
REMP of AcNb and BaNb.^{a}

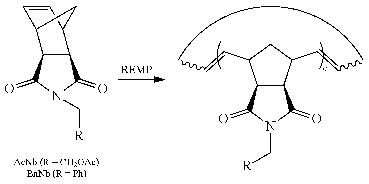

| | | | M_{n,theor} | Mₙ^{b} | M_{w}^{b} | |
|---|---|---|---|---|---|---|
| M | I | [I:M]₀ | (kDa) | (kDa) | (kDa) | Ð^{b} |
| AcNb | UC5 | 1:50 | 12.5 | 421 | 572 | 1.36 |
| AcNb | CB6 | 1:50 | 12.5 | 43.6 | 65.0 | 1.49 |
| AcNb | UC5 | 1:200 | 49.9 | 1220 | 1760 | 1.44 |
| AcNb | CB6 | 1:200 | 49.9 | 183 | 258 | 1.41 |
| AcNb | CB6 | 1:250 | 62.3 | 193 | 274 | 1.42 |
| AcNb | CB6 | 1:320 | 79.8 | 245 | 348 | 1.42 |
| AcNb | CB6 | 1:550 | 137 | 393 | 539 | 1.37 |
| BnNb | UC5 | 1:100 | 25.3 | 954 | 1240 | 1.30 |
| BnNb | CB6 | 1:100 | 25.3 | 133 | 182 | 1.37 |
| BnNb | UC5 | 1:200 | 50.6 | 1380 | 1740 | 1.26 |
| BnNb | CB6 | 1:200 | 50.6 | 148 | 213 | 1.44 |
| BnNb | CB6 | 1:500 | 127 | 170 | 251 | 1.48 |
| BnNb | CB6 | 1:800 | 202 | 200 | 298 | 1.49 |

^{a}Polymerization reactions were stirred at 55° C. in DCE for 12 h under nitrogen.
^{b}Determined by GPC-MALS-IV (CHCl₃, 35° C.).

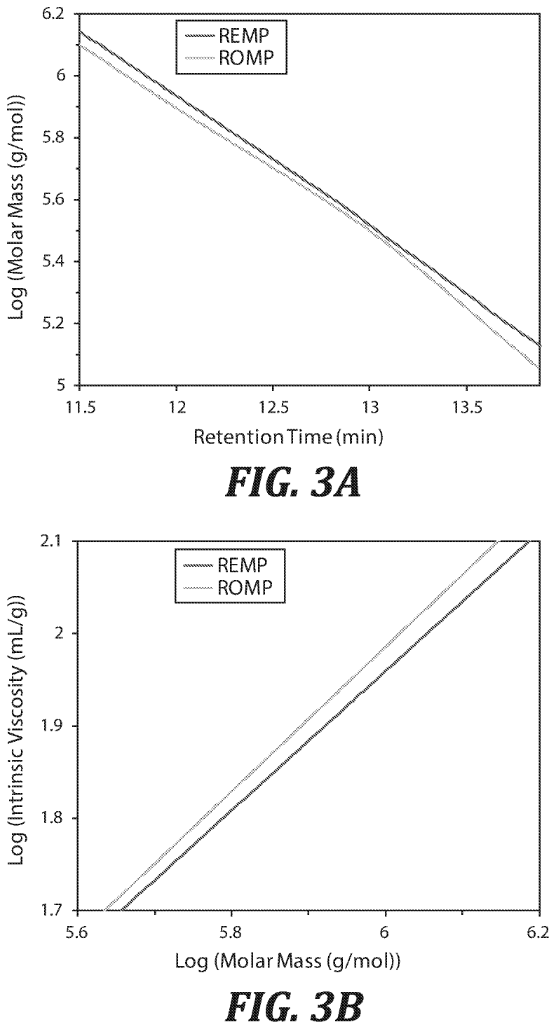

To evaluate the cyclic polymer architecture accessed from CB6, polymers derived from G2 and CB6 with the same number-average molecular weight (Mₙ) were analyzed by GPC-MALS-IV. A comparison between linear and cyclic polymers with identical molar masses reveals the macrocycle's smaller hydrodynamic radius (i.e., longer retention time) and lower intrinsic viscosity. Indeed, plots of molar mass versus retention time for polymers initiated with G2 and CB6 (Mₙ=183 kDa for AcNb polymers and Mₙ=170 kDa for BnNb polymers) reveal that the cyclic structures have larger molar masses than linear ones over a broad range of retention times (see FIG. 3A). Evaluation of Mark-Houwink-Sakurada (MHS) plots for the same groups of polymers reveals that η_{cyclic}/ηₗᵢₙₑₐᵣ≈0.93 for both AcNb and BnNb polymers (see FIG. 3B); as expected, the cyclic polymers have a lower intrinsic viscosity than the corresponding linear polymers (η_{cyclic}<ηₗᵢₙₑₐᵣ). Additionally, both pairs of polymers have nearly identical MHS a values (0.754-0.783 for poly (AcNb) and 0.742-0.735 for poly (BnNb)) which confirms similar backbone-independent conformations. Previous works report η_{cyclic}/ηₗᵢₙₑₐᵣ ratios between 0.33-0.92; it is unclear if these discrepancies are due to sample purity, backbone-related phenomena, and/or Mₙ dependence on viscosity.

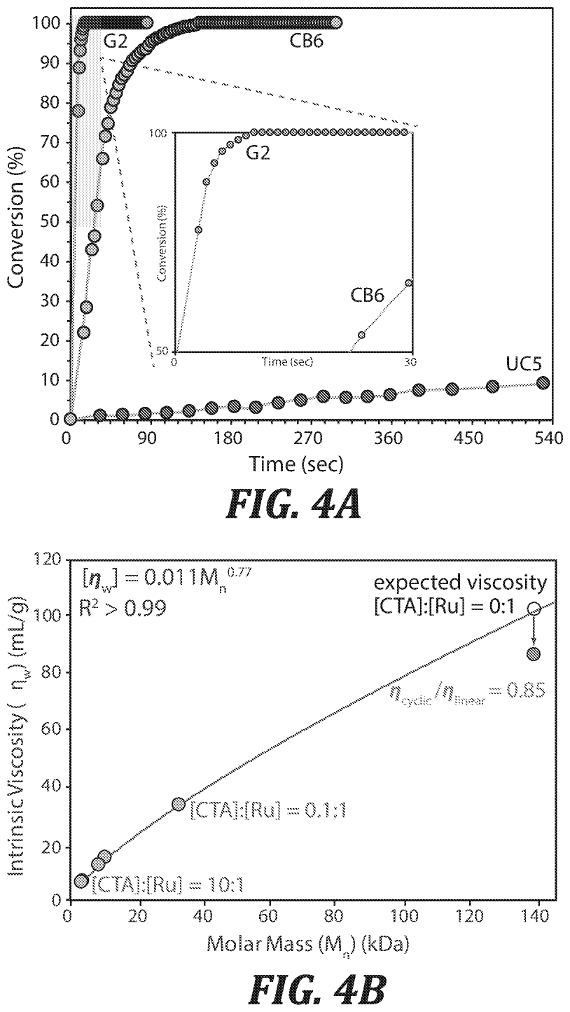

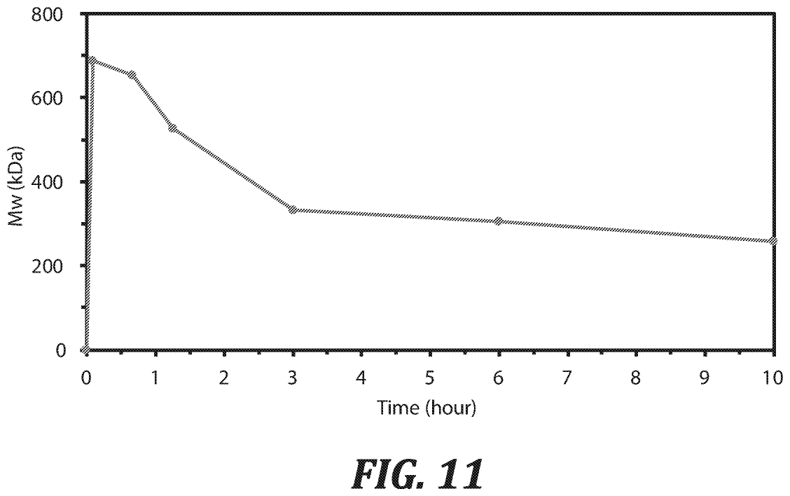

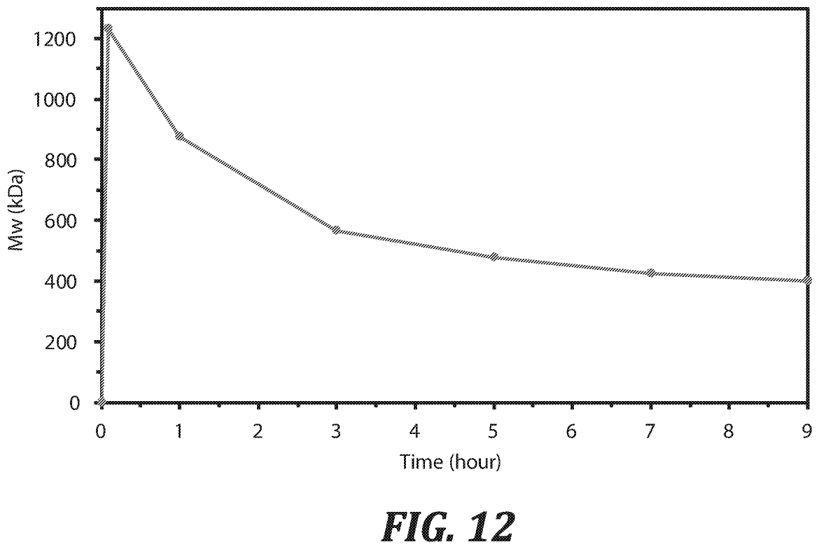

Polymerization kinetics (FIG. 2, i & ii) of AcNb using either UC5, CB6, or G2 were studied in situ using ¹H NMR spectroscopy (DCE-d4, 55° C.). Reactions initiated with UC5 showed sluggish rates as expected based on previous work by Grubbs (Boydston, A. J.; Xia. Y.; Kornfield, J. A.; Gorodetskaya, I. A.; Grubbs, R. H. Cyclic Ruthenium-Alkylidene Catalysts for Ring-Expansion Metathesis Polymerization. J. Am. Chem. Soc. 2008, 130, 12775-12782; Xia, Y.; Boydston, J. A.; Yao, Y.; Kornfield, A. J.; Gorodetskaya, A. I.; Spiess, W. H.; Grubbs, R. H. Ring-Expansion Metathesis Polymerization: Catalyst Dependent Polymerization Profiles. J. Am. Chem. Soc. 2009, 131, 2670-2677. https://doi.org/10.1021/ja808296a (FIG. 4A). Excitingly, reactions initiated with CB6 showed a drastic increase in rate compared to that of UC5. In under 5min, full monomer conversion was observed using CB6 while UC5 affected <10% monomer conversion. The structural similarities between CB6 and G2 undoubtedly led to the difference in kinetics. For polymerizations of AcNb (FIG. 11) and BnNb (FIG. 12) with CB6, a sharp increase in M_{w} occurred just after full monomer consumption, followed by a quick decrease in M_{w}. The equilibrium-controlled molar mass is nearly reached in three hours, providing expedited kinetics compared to that of UC5.

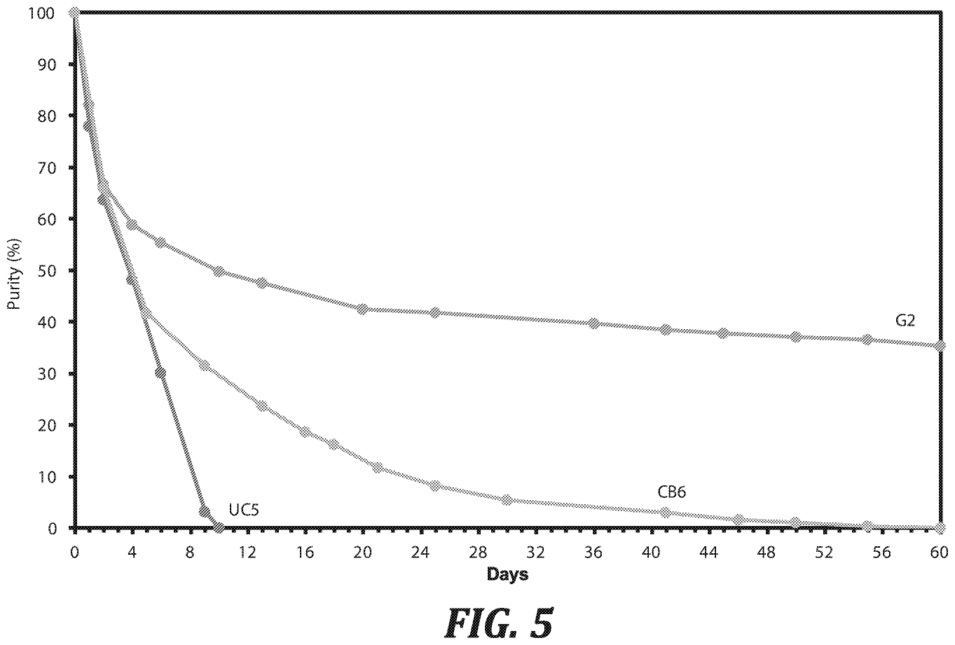

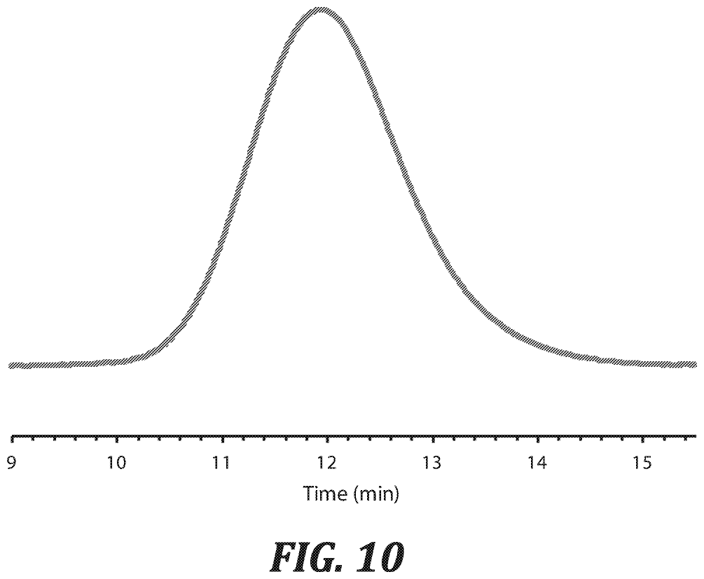

In accordance with efforts to make REMP a more accessible technology, the relative stability of CB6 was evaluated. Solution-state stability is important because linear impurities generated during REMP are often attributed to initiator decomposition. Dissolution of CB6, UC5, and G2 in benzene-d6 at room temperature allowed for the monitoring of the characteristic downfield benzylidene peak (or alkylidene peak in the case of UC5) as a function of time (FIG. 5) by ¹H NMR spectroscopy. Under nitrogen, CB6 is less stable than benchmark G2 but persists longer in solution than UC5. CB6 has a significantly longer shelf life (−20° C. under nitrogen) than UC5. CB6 remains unchanged with similar activity for at least 5 months while UC5 decomposes over less than 3 months. As a final testament to the robustness of CB6, REMP on the benchtop under air ([I:AcNb]=1:200) afforded a cyclic poly(norbornene) as determined by GPC-MALS-IV (FIG. 10), albeit with considerably higher Mₙ than expected, presumably due to expedited initiator oxidation. Interestingly, the measured Mₙ (388 kDa) was still closer to the theoretical Mₙ than the Mₙ for the identical reaction conducted under an inert atmosphere with UC5 (Table 1).

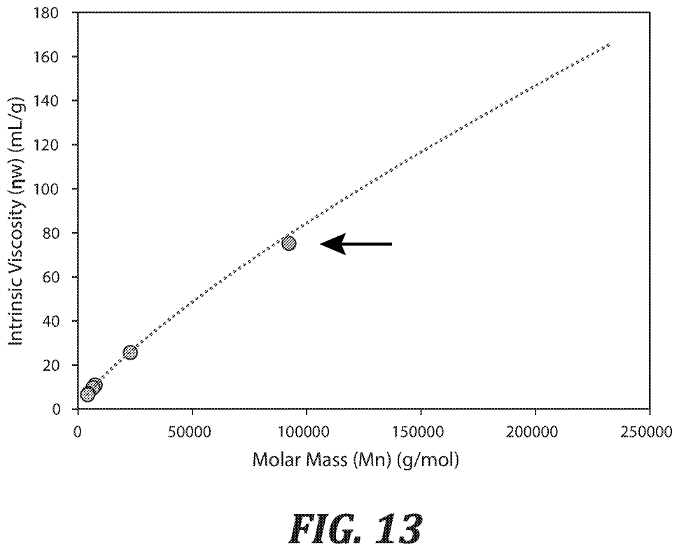

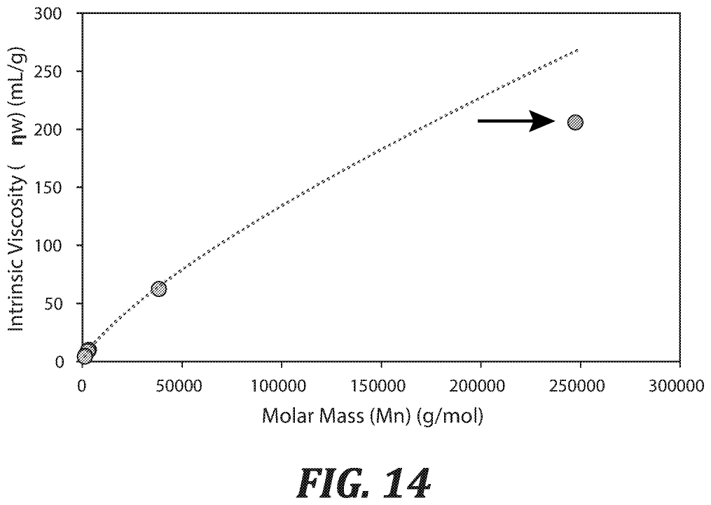

To further confirm that CB6 initiated REMP resulted in cyclic polymers, chain-transfer experiments were performed using 3-hexene as the chain-transfer agent (CTA) to purposefully generate linear impurities. The linear fragments should follow a MHS relationship (η=KM^{a}) as a function of CTA concentration; deviation from this trend at [CTA]₀=0 would only be expected if there was a change in architecture. Accordingly, ROMP of AcNb with G2 ([I:M]₀=1:200) in the presence of CTA ([CTA]:[Ru]=0:1-10:1) afforded linear polymers that fit the MHS relationship (FIG. 13). On the other hand, REMP of AcNb with CB6 and UC5 using identical CTA ratios produced polymers that also fit the MHS relationship, albeit with crucial outliers at [CTA]₀=0 (see FIG. 4B and FIG. 14). Because cyclic polymers have lower viscosities than their linear counterparts, the observed deviations suggest a change in cyclic to acyclic architecture upon addition of CTA. In other words, lower viscosity (η_{cyclic}/ηₗᵢₙₑₐᵣ=0.77-0.85) polymers were only generated in the absence of CTA; CTA-mediated chain scission results in decreased molar masses and viscosities for linear structures and topological changes via ring opening when cyclic macromolecules are present.

The present disclosure demonstrates the utility of a novel cyclic Ru-NHC complex, CB6, to synthesize cyclic poly (norbornenes). Based on the drastic improvements in molecular weight control, reaction kinetics, and initiator stability, CB6 serves as a building block for a platform of REMP initiators.

### Definitions

At various places in the present specification, substituents of compounds of the disclosure are disclosed in groups or in ranges. It is specifically intended that the disclosure include each and every individual subcombination of the members of such groups and ranges. For example, the term “C₁₋₆ alkyl” is specifically intended to individually disclose methyl, ethyl, C₃ alkyl, C₄ alkyl, C₅ alkyl, and C₆ alkyl. As an example, the term “optionally substituted with 1, 2, 3, 4, or 5” is intended to individually disclose optionally substituted with 1, 2, 3, or 4; 1, 2, or 3; 1 or 2; or 1 substituents.

It is further intended that the compounds of the disclosure are stable. As used herein “stable” refers to a compound that is sufficiently robust to survive isolation to a useful degree of purity from a reaction mixture.

It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

The verb “comprise” and its conjugations, are used in the open and non-limiting sense to mean that items following the word are included, but items not specifically mentioned are not excluded.

“About” in reference to a numerical value refers to the range of values somewhat less or greater than the stated value, as understood by one of skill in the art. For example, the term “about” could mean a value ranging from plus or minus a percentage (e.g., ±1%, ±2%, or ±5%) of the stated value. Furthermore, since all numbers, values, and expressions referring to quantities used herein are subject to the various uncertainties of measurement encountered in the art, then unless otherwise indicated, all presented values may be understood as modified by the term “about.”

As used herein, the articles “a,” “an,” and “the” may include plural referents unless otherwise expressly limited to one-referent, or if it would be obvious to a skilled artisan from the context of the sentence that the article referred to a singular referent.

Where a numerical range is disclosed herein, then such a range is continuous, inclusive of both the minimum and maximum values of the range, as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all subranges subsumed therein. For example, a stated range of from “1 to 10” should be considered to include 1 and 10, and any and all subranges between the minimum value of 1 and the maximum value of 10. Exemplary subranges of the range “1 to 10” include, but are not limited to, e.g., 1 to 6.1, 3.5 to 7.8, and 5.5 to 10.

It is intended that divalent groups, such as linking groups (e.g., alkylene, arylene, etc.) between a first and a second moieties, can be oriented in both forward and the reverse direction with respect to the first and second moieties, unless specifically described.

“Optionally substituted” groups can refer to, for example, functional groups that may be substituted or unsubstituted by additional functional groups. For example, when a group is unsubstituted, it can be referred to as the group name, for example alkyl or aryl. When a group is substituted with additional functional groups, it may more generically be referred to as substituted alkyl or substituted aryl.

As used herein, the term “substituted” or “substitution” refers to the replacing of a hydrogen atom with a substituent other than H. For example, an “N-substituted piperidin-4-yl” refers to replacement of the H atom from the NH of the piperidinyl with a non-hydrogen substituent such as, for example, alkyl.

As used herein, the term “alkyl” refers to a straight or branched hydrocarbon group. In some embodiments, alkyl has 1 to 10 carbon atoms (e.g., 1 to 8 carbon atoms, 1 to 6 carbon atoms, 1 to 3 carbon atoms, 1 or 2 carbon atoms, or 1 carbon atom). Representative alkyl groups include methyl, ethyl, propyl (e.g., n-propyl, isopropyl), butyl (e.g., n-butyl, sec-butyl, and tert-butyl), pentyl (e.g., n-pentyl, tert-pentyl, neopentyl, isopentyl, pentan-2-yl, pentan-3-yl), and hexyl (e.g., n-hexyl and isomers) groups.

As used herein, the term “alkylene” refers to a linking alkyl group.

As used herein, the term “cycloalkyl” refers to non-aromatic carbocycles including cyclized alkyl, alkenyl, and alkynyl groups. Cycloalkyl groups can include mono-or polycyclic (e.g., having 2, 3 or 4 fused rings) ring systems, including spirocycles. In some embodiments, cycloalkyl groups can have from 3 to about 20 carbon atoms, 3 to about 14 carbon atoms, 3 to about 10 carbon atoms, or 3 to 7 carbon atoms. Cycloalkyl groups can further have 0, 1, 2, or 3 double bonds and/or 0, 1, or 2 triple bonds. Also included in the definition of cycloalkyl are moieties that have one or more aromatic rings fused (i.e., having a bond in common with) to the cycloalkyl ring, for example, benzo derivatives of pentane, pentene, hexane, and the like. A cycloalkyl group having one or more fused aromatic rings can be attached though either the aromatic or non-aromatic portion. One or more ring-forming carbon atoms of a cycloalkyl group can be oxidized, for example, having an oxo or sulfido substituent. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbomyl, norpinyl, norcamyl, adamantyl, and the like.

As used herein, the term “cycloalkylene” refers to a linking cycloalkyl group. As used herein, the term “perfluoroalkyl” refers to straight or branched fluorocarbon chains. In some embodiments, perfluoroalkyl has 1 to 10 carbon atoms (e.g., 1 to 8 carbon atoms, 1 to 6 carbon atoms, 1 to 3 carbon atoms, 1 or 2 carbon atoms, or 1 carbon atom). Representative alkyl groups include trifluoromethyl, pentafluoroethyl, etc.

As used herein, the term “perfluoroalkylene” refers to a linking perfluoroalkyl group.

As used herein, the term “heteroalkyl” refers to a straight or branched chain alkyl groups and where one or more of the carbon atoms is replaced with a heteroatom selected from O, N, or S. In some embodiments, heteroalkyl alkyl has 1 to 10 carbon atoms (e.g., 1 to 8 carbon atoms, 1 to 6 carbon atoms, 1 to 3 carbon atoms, 1 or 2 carbon atoms, or 1 carbon atom).

As used herein, the term “heteroalkylene” refers to a linking heteroalkyl group.

As used herein, the term “alkoxy” refers to an alkyl or cycloalkyl group as described herein bonded to an oxygen atom. In some embodiments, alkoxy has 1 to 10 carbon atoms (e.g., 1 to 8 carbon atoms, 1 to 6 carbon atoms, 1 to 3 carbon atoms, 1 or 2 carbon atoms, or 1 carbon atom). Representative alkoxy groups include methoxy, ethoxy, propoxy, and isopropoxy groups.

As used herein, the term “perfluoroalkoxy” refers to a perfluoroalkyl or cyclic perfluoroalkyl group as described herein bonded to an oxygen atom. In some embodiments, perfluoroalkoxy has 1 to 10 carbon atoms (e.g., 1 to 8 carbon atoms, 1 to 6 carbon atoms, 1 to 3 carbon atoms, 1 or 2 carbon atoms, or 1 carbon atom). Representative perfluoroalkoxy groups include trifluoromethoxy, pentafluoroethoxy, etc.

As used herein, the term “aryl” refers to an aromatic hydrocarbon group having 6to 10 carbon atoms. Representative aryl groups include phenyl groups. In some embodiments, the term “aryl” includes monocyclic or polycyclic (e.g., having 2, 3, or 4 fused rings) aromatic hydrocarbons such as, for example, phenyl, naphthyl, anthracenyl, phenanthrenyl, indanyl, and indenyl.

As used herein, the term “arylene” refers to a linking aryl group. For example, the term “phenylene” refers to a linking phenyl group.

As used herein, the term “aralkyl” refers to an alkyl or cycloalkyl group as defined herein with an aryl group as defined herein substituted for one of the alkyl hydrogen atoms. A representative aralkyl group is a benzyl group.

As used herein, the term “aralkylene” refers to a linking aralkyl group.

As used herein, the term “heteroaryl” refers to a 5- to 10-membered aromatic monocyclic or bicyclic ring containing 1-4 heteroatoms selected from O, S, and N. Representative 5- or 6-membered aromatic monocyclic ring groups include pyridine, pyrimidine, pyridazine, furan, thiophene, thiazole, oxazole, and isooxazole. Representative 9- or 10-membered aromatic bicyclic ring groups include benzofuran, benzothiophene, indole, pyranopyrrole, benzopyran, quinoline, benzocyclohexyl, and naphthyridine.

As used herein, the term “heteroary lene” refers to a linking heteroaryl group.

As used herein, the term “heteroaralkyl” refers to an alkyl or cycloalkyl group as defined herein with an aryl or a heteroaryl group as defined herein substituted for one of the alkyl hydrogen atoms. For example, a representative aralkyl group is a benzyl group.

As used herein, the term “heteroaralkylene” refers to a linking heteroaralkyl group.

As used herein, the term “halogen” or “halo” refers to fluoro, chloro, bromo, and iodo groups.

As used herein, “ring expansion metathesis polymerization” (REMP) refers to a polymerization to form cyclic polymers by the insertion of monomers (usually, but not necessarily cyclic monomers) into reactive bonds of a cyclic metathesis initiator and growing cyclic chains via a metathesis reaction facilitated by a cyclic metathesis initiator.

As used herein, an initiator for REMP refers to a compound that facilitates monomer insertion into the macrocyclic organometallic template via cross-metathesis, and also promotes intramolecular chain-transfer (“back-biting”) via intramolecular cross-metathesis to ultimately generate a given cyclic polymer.

As used herein, the term “cyclic polymer” refers to a polymer having at least one macrocycle formed of a plurality of repeating units.

As used herein, the term “copolymer” refers to a polymer that is the result of polymerization of two or more different monomers. The number and the nature of each constitutional unit can be separately controlled in a copolymer. The constitutional units can be disposed in a purely random, an alternating random, a regular alternating, a regular block, or a random block configuration unless expressly stated to be otherwise. A purely random configuration can, for example, be: x-x-y-z-x-y-y-z-y-z-z-z . . . or y-z-x-y-z-y-z-x-x . . . . An alternating random configuration can be: x-y-x-z-y-x-y-z-y-x-z . . . , and a regular alternating configuration can be: x-y-z-x-y-z-x-y-z . . . . A regular block configuration (i.e., a block copolymer) has the following general configuration: . . . x-x-x-y-y-y-z-z-z-x-x-x . . . , while a random block configuration has the general configuration of, for example: . . . x-x-x-z-z-x-x-y-y-y-y-z-z-z-x-x-z-z-z . . . , or for example, . . . x-x-x-y-y-y-y-x-x-y-y-y-x-x-x-y-y . . .

As used herein, the term “random copolymer” is a copolymer having an uncontrolled mixture of two or more constitutional units. The distribution of the constitutional units throughout a polymer backbone (or main chain) can be a statistical distribution, or approach a statistical distribution, of the constitutional units. In some embodiments, the distribution of one or more of the constitutional units is favored.

As used herein, the term “constitutional unit” of a polymer refers to an atom or group of atoms in a polymer, comprising a part of the chain together with its pendant atoms or groups of atoms, if any. The constitutional unit can refer to a repeating unit. The constitutional unit can also refer to an end group on a polymer chain. For example, the constitutional unit of polyethylene glycol can be —CH₂CH₂O—corresponding to a repeating unit, or —CH₂CH₂OH corresponding to an end group.

As used herein, the term “repeating unit” corresponds to the smallest constitutional unit, the repetition of which constitutes a regular macromolecule (or oligomer molecule or block).

As used herein, the term “end group” refers to a constitutional unit with only one attachment to a polymer chain, located at the end of a polymer. For example, the end group can be derived from a monomer unit at the end of the polymer, once the monomer unit has been polymerized. As another example, the end group can be a part of a chain transfer agent or initiating agent that was used to synthesize the polymer.

As used herein, the term “terminus” of a polymer refers to a constitutional unit of the polymer that is positioned at the end of a polymer backbone.

As used herein, the term “terminal group” refers to a functional group positioned at the end of a polymer backbone.

As used herein, the term “cationic” refers to a moiety that is positively charged, or ionizable to a positively charged moiety under physiological conditions. Examples of cationic moieties include, for example, amino, ammonium, pyridinium, imino, sulfonium, quaternary phosphonium groups, etc.

As used herein, the term “anionic” refers to a functional group that is negatively charged, or ionizable to a negatively charged moiety under physiological conditions. Examples of anionic groups include carboxylate, sulfate, sulfonate, phosphate, etc.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The following examples are provided for the purpose of illustrating, not limiting, the invention.

### EXAMPLES

The following describes the preparation, characterization, and use of a representative cyclic ruthenium-benzylidene initiator (CB6) for ring-expansion metathesis polymerization reactions. The preparation, characterization, and use of representative cyclic alkene monomers and comparative ruthenium initiators is also described.

Materials. All reagents were purchased from commercial suppliers and used as received unless otherwise noted. Glassware was flame dried or dried in an oven overnight at 120°° C. before use. Degassed and anhydrous tetrahydrofuran (THF), dichloromethane (DCM), benzene (C₆H₆), and pentane were obtained from a solvent purification system. Toluene, 1,4-dioxane, and dimethylformamide (DMF) were dried over 3 Å molecular sieves for at least 3 days before use. 1,2-dichloroethane (DCE) and chloroform (CHCl₃) were fractionally distilled and stored over 3 Å molecular sieves before use. Triethyl orthoformate was dried over sodium sulfate and distilled from potassium hydroxide, degassed, and stored over 3 Å molecular sieves before use. All moisture and air-sensitive reactions were performed under inert atmosphere (nitrogen) using standard Schlenk technique or, when noted, in a Vacuum Atmosphere glovebox. SiliaFlash F60 (40-63 μm, 230-400 mesh) silica gel was used for column chromatography. Automated flash chromatography was performed using a Yamazen Smart Flash AKROS system.

Characterization. ¹H nuclear magnetic resonance (¹H NMR), ¹³C nuclear magnetic resonance (¹³C NMR), and ³¹P nuclear magnetic resonance (³¹P NMR) spectra were obtained on a Bruker AVANCE-300, Bruker AVANCE-500, or Bruker DRX-500 NMR spectrometer. ¹H NMR spectra were taken in chloroform-d (CDCl₃, referenced to TMS, δ0.00 ppm), 1,2-dichloroethane-d4 (C₂D₄Cl₂, referenced to residual C₂H₄Cl₂, δ3.72 ppm), and benzene-d6 (C₆D₆, referenced to residual C₆H₆, δ7.16 ppm). All ¹³C NMR spectra were taken in chloroform-d (referenced to chloroform, δ77.16 ppm) and benzene-d6 (referenced to benzene, δ128.06 ppm). ³¹P NMR spectra were externally referenced to 85% H₃PO₄ (0.00 ppm). Spectra were analyzed on TopSpin software. Chemical shifts are represented in parts per million (ppm); splitting patterns are assigned as s (singlet), d (doublet), t (triplet), q (quartet), p (quintet), m (multiplet), and br (broad); coupling constants, J, are reported in hertz (Hz).

Gel permeation chromatography (GPC) data were collected on Agilent 1260 HPLC equipped with a Wyatt 8-angle DAWN NEON light-scattering detector, ViscoStar NEON viscometer, and Optilab NEON refractive index detector. GPC samples were analyzed at a flow rate of 1 mL/min in chloroform stabilized with 0.5%-1.0% ethanol through two Agilent PLgel MIXED-C columns at 35° C. dn/dc values were determined by the 100% mass recovery method using Wyatt Astra 7.3 software. High-resolution mass spectroscopy (HRMS) data were collected on an LTQ Orbitrap (ThermoScientific) operating in positive mode electrospray ionization. Instrument resolution was set to 60000 and elemental composition was confirmed by electrospray ionization HRMS. X-ray crystallography data was collected at −173° C. (100 K) on a Nonius Kappa CCD FR590 single crystal X-ray diffractometer, Mo-radiation. The data was integrated and scaled using SAINT, SADABS within the APEX2 software package by Bruker.

### Example 1

### The Preparation and Characterization of a Representative Cyclic Ruthenium-Benzylidene Initiator (CB6)

In this example, the preparation and characterization of a representative ruthenium-benzylidene initiator (CB6) useful for ring-expansion metathesis polymerization is described. The preparation of CB6 and its x-ray structure are illustrated in FIG. 15.

### 1. Synthesis of 4-((6-bromohexyl)oxy)benzaldehyde (1)

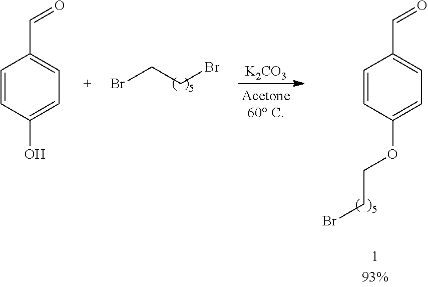

To a round bottom flask equipped with a stir bar was added 4-hydroxylaldehyde (5.00 g, 40.9 mmol), 1,6-dibromohexane (18.9 mL, 123 mmol), potassium carbonate (9.61 g, 69.6 mmol), and 90.0 mL (90 mL). The round bottom flask was then attached to an air condenser and refluxed at 60° C. for 2 d (monitored by NMR). The reaction was cooled to room temperature and extracted with ethyl acetate (100 mL) and washed with water (30 mL×3), brine (20 mL×2). The organic layer was then dried over sodium sulfate, filtered, and concentrated under vacuum. The crude yellow oil was eluted with a DCM/hexane (50:50) solvent mixture on a silica column to yield 1 as a white solid (11.15 g, 93%). ¹H NMR (300 MHz, CDCl₃): δ(ppm) 9.86 (s, 1H), 7.81 (d, J=8.3 Hz, 2H), 6.97 (d, J=8.3 Hz, 2H), 4.03 (t, J=6.7 Hz, 2H), 3.41 (t, J=6.7 Hz, 2H), 1.85 (overlap, 4H), 1.51 (overlap, 4H); ¹³C NMR (75 MHz, CDCl₃): δ(ppm) 190.63, 164.14, 131.93, 129.93, 114.76, 68.14 33.53 32.59 28.87 27.83 25.19.

### 2. Synthesis of 4-((6-(4-bromo-3,5-dimethylphenoxy)hexyl)oxy)benzaldehyde (2)

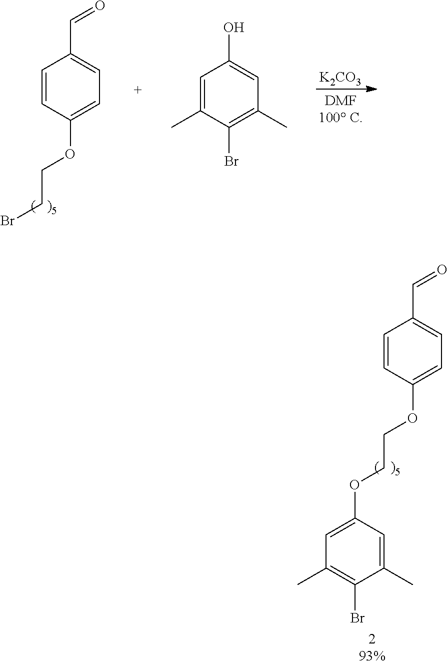

To a round bottom flask equipped with a stir bar was added 1 (4.00 g, 14.0 mmol), 4-bromo-3,5-dimethylphenol (3.38 g, 16.8 mmol), and potassium carbonate (3.29 g, 23.8 mmol) was added. The same flask was charged with DMF (150 mL) and the reaction mixture was stirred at 100° C. for 24 hr. The reaction was cooled to room temperature then extracted with ethyl acetate (150 mL). The organic layer was washed with 3% lithium chloride solution (15 mL×3), DI water (15 mL×5), and brine (15 mL×2). The organic layer was dried over sodium sulfate, filtered, and concentrated under vacuum. The crude oil was purified on a silica column using ethyl acetate/hexane (2:8) solvent mixture to yield 2 as a white solid (5.68 g. 97%). ¹H NMR (300 MHz, CDCl₃): δ(ppm) 9.86 (s, 1H), 7.81 (d, J=8.8 Hz, 2H), 6.97 (d, J=8.8 Hz, 2H), 6.63 (s, 2H) 4.03 (t, J=6.5 Hz, 2H), 3.41 (t, J=6.4 Hz, 2H), 2.37 (s, 6H), 1.85 (overlap, 4H), 1.51 (overlap, 4H); ¹³C NMR (75 MHz, CDCl₃): δ(ppm) 190.64, 164.26, 157.77, 139.03, 131.93, 129.93, 114.76, 114.47, 68.23, 67.85, 29.15, 28.99, 25.75, 23.96. HRMS m/z calcd for C₂₁H₂₅O₃ [M⁺] 405.106, found 405.106.

### 3. Synthesis of 2-bromo-1,3-dimethyl-5-((6-(4-vinylphenoxy)hexyl)oxy)benzene (3)

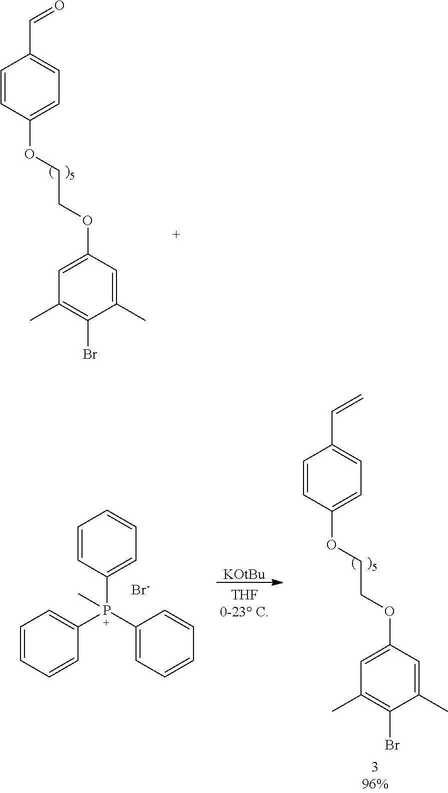

To a Schlenk flask equipped with a stir bar was added methyltriphenylphosphonium bromide (1.05 g, 2.96 mmol) and dry THF (10 mL). The flask was purged with nitrogen and the solution was cooled to 0° C. Potassium tert-butoxide (0.550 g, 4.93 mmol) was then added to the Schlenk flask under a stream of nitrogen. The mixture was stirred at 0° C. for 10 min. In a separate flask, 2 (1.00 g, 246 mmol) was dissolved in 20 mL of dried THF under nitrogen and transferred (via cannula) to the Schlenk flask. The mixture was stirred at 0° C. for 15 min then the ice bath was removed. The reaction continued to stir at room temperature for 12 hr. Once the reaction was complete, the solution was quenched with methanol. Solvent was evaporated under vacuum. The residue was dissolved in DCM (20 mL) and washed with H₂O (30 mL×3), and brine (30 mL×3). The organic phase was then dried on sodium sulfate and concentrated under vacuum. The crude product was then loaded onto a silica column and the product was eluted with EtOAc/hexane (2:8) to yield 3 as a white solid (0.920 g, 96%). ¹H NMR (300 MHz, CDCl₃): δ(ppm) 7.35 (d, J=8.7 Hz, 2H), 6.86 (d, J=8.8 Hz, 2H), 6.69-6.574 (m, 1H) 6.63 (s, 2H), 5.62 (d, J=18.9 Hz, 1H), 5.13 (d, J=11.9 Hz, 1H), 3.95 (overlap, 4H), 2.39 (s, 6H), 1.82 (overlap, 4H), 1.54 (overlap, 4H); ¹³C NMR (75 MHz, CDCl₃): δ(ppm) 158.92, 157.62, 139.04, 136.31, 130.43, 127.37, 118.13, 114.54, 111.45, 67.92, 29.22, 25.85, 24.01. HRMS m/z calcd for C₂₂H₂₈O₂ [M⁺] 403.1267, found 4.03.1267.

### 4. Synthesis of N-mesitylethane-1,2-diamine-HBr salt (4a)

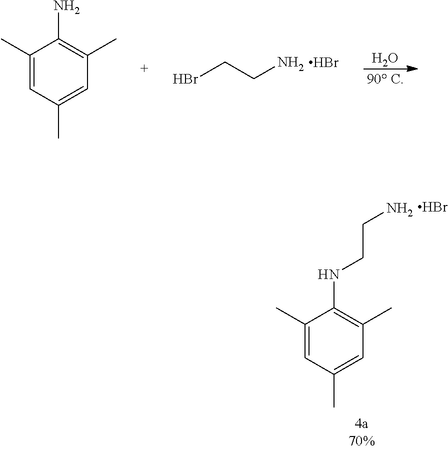

To a round bottom flask equipped with a stir bar was added 2,4,6-trimethyl aniline (20.0 g, 147.9 mmol) and 2-bromoethylamine hydrobromide (15.2 g, 74.0 mmol). The solids were dissolved in H₂O (40 mL). The flask was equipped with a condenser and the mixture was stirred at 90° C. for 12 hr. The reaction was cooled to room temperature, extracted with water (50 mL), and washed with EtOAc (50 mL×3). The aqueous layer was collected and concentrated under vacuum. The solid residue was crystallized from hot EtOAc/methanol (2:1) to yield 4a as a white solid (13.40 g, 70%) after filtering under vacuum and washing with minimal cold EtOAc. The solid HBr salt 4a was stored for at least 3 months at a time in a desiccator. NMR data is consistent with reported values.

### 5. Synthesis of N-mesitylethane-1,2-diamine (4)

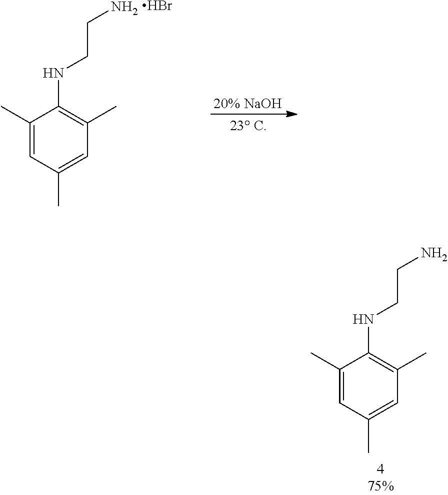

To a round bottom flask equipped with a stir bar was added 4a (1.00 g, 3.85 mmol) and 20% aq. NaOH (20 mL). The solution was stirred for 30 min at room temperature. The solution was extracted with DCM (20 mL×3) and the combined organics were washed with water (15 mL×3) and brine (15 mL×2). The organic phase was dried over sodium sulfate and concentrated under vacuum to yield 4 as a yellow oil (0.480 g, 70%). Fresh 4 was used within 24 hr (stored under nitrogen at 4° C.) of free-basing HBr salt 4a. The yield of the subsequent amination reaction to generate 5 was significantly lower if 4 was not generated fresh. ¹H NMR (300 MHz, CDCl₃): δ(ppm) 6.92 (s, 2H), 3.06 (m, 2H) 2.97 (m, 2H) 2.38 (s, 6H), 2.33 (s, 2H), 2.12 (br, 3H; ¹³C NMR (75 MHz, CDCl₃): δ(ppm) 143.65, 131.18, 129.79, 129.48, 51.34, 42.63, 20.60, 18.39.

### 6. Synthesis of N-(2,6-dimethyl-4-(4-(4-vinylphenoxy)butoxy)phenyl)-N-(3,4,5-trimethylphenyl)ethane-1,2-diamine (5)

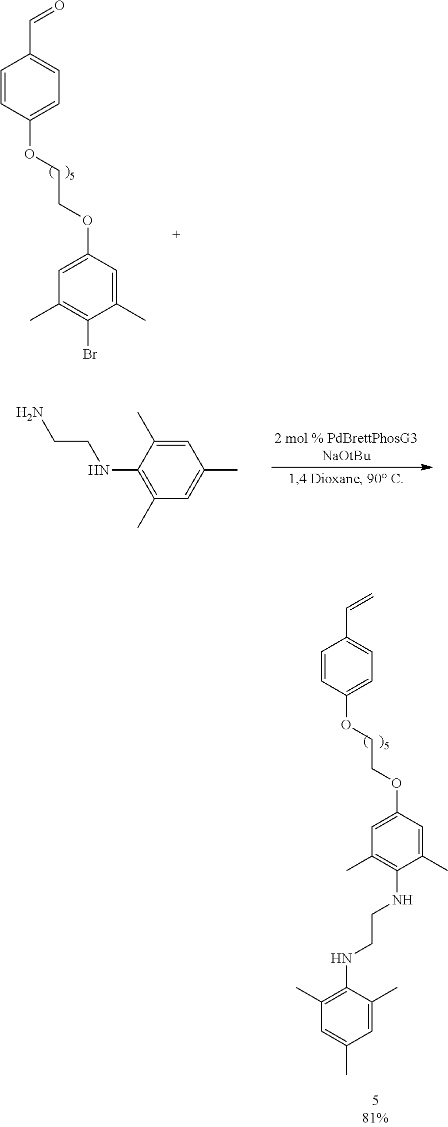

To a dry 20 mL screw-cap vial equipped with a stir bar was added 3 (1.00 g, 2.66 mmol) and Pd-PEPPSI-IPr (0.217 g, 0.320 mmol). T o a separate dry 8 mL vial was added 4 (0.665 g, 3.73 mmol). Under a nitrogen atmosphere (glovebox), sodium tert-butoxide (0.383 g, 3.97 mmol) was added to the vial containing 3 and Pd-PEPPSI-IPr. Amine 4 was then dissolved in THF (2 mL) and this solution was added to the solids in the other vial. The reaction mixture was then stirred for one min at room temperature and two min at 60° C. After two min, additional THF (4 mL) was added and the reaction was stirred for 16 h at 60° C. The reaction mixture was then cooled to room temperature and filtered through a bed of Celite (washed with ethyl acetate and DCM). The filtrate was concentrated under vacuum and purified via silica gel chromatography (0-15% ethyl acetate: hexane) to afford 5 as a yellow oil (0.890 g, 71%) ¹H NMR (300 MHz, CDCl₃): δ(ppm) 7.34 (d, J=8.7 Hz, 2H), 6.86 (overlap, 4H), 6.67 (dd, J=17.6, 10.9 Hz, 1H), 6.59 (s, 2H), 5.61 (d, J=17.6 Hz, 1H), 5.12 (d, J=10.9 Hz, 1H), 3.97 (t, J=18.4, 6.4 Hz, 2H), 3.91 (t, J=18.2, 6.4 Hz, 2H), 3.13 (m, 4H), 2.30 (s, 12H), 2.24 (s, 3H), 1.82 (overlap, 4H), 1.55 (overlap, 4H); ¹³C NMR (75 MHz, CDCl₃): δ(ppm) 159.05, 154.57, 143.54, 139.16, 136.42, 132.04, 131.39, 130.43, 129.73, 129.60, 127.44, 114.82, 114.64, 111.46, 68.03, 49.68, 49.34, 29.47, 29.33, 25.99, 20.61, 18.64, 18.50. HRMS m/z calcd for C₃₃H₄₅O₂N₂ [M⁺] 501.3476, found 501.3481.

### 7. Synthesis of 3-(2,6-dimethyl-4-(4-(4-vinylphenoxy)butoxy)phenyl)-1-mesityl-4,5-dihydro-imidazol-3-ium salt (6)

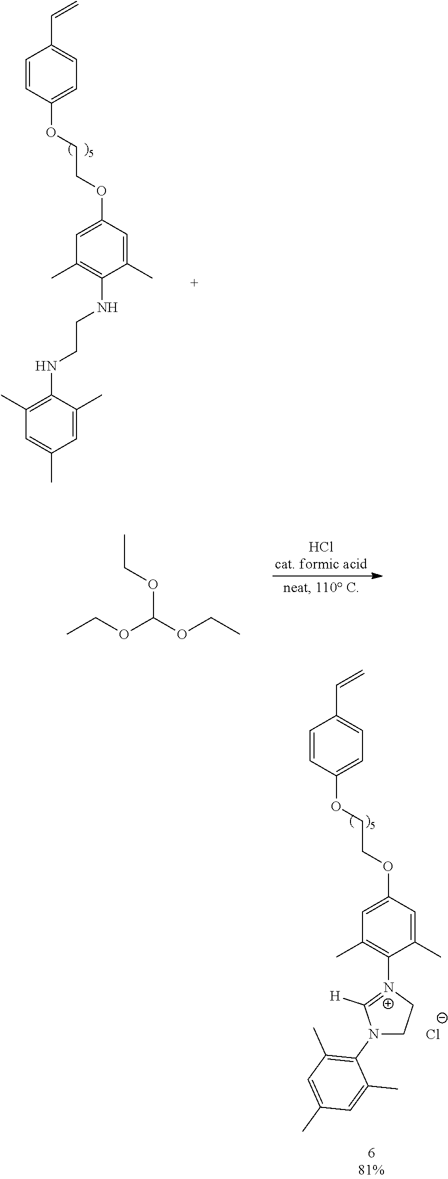

To a Schlenk flask equipped with a stir bar was added 5 (0.400 g, 0.800 mmol) and dry toluene (3 mL) under nitrogen. 2M HCl in diethyl ether (0.660 mL, 6.07 mmol) was added to the flask and stirred for 20 min at room temperature. After 20 minutes, 1 drop of formic acid and triethyl orthoformate (4.03 mL, 24.38 mmol) were added to the vessel and the mixture was stirred at 110° C. for 15 min. The reaction was cooled to room temperature and concentrated under vacuum. The crude mixture was loaded onto a silica column and the product was eluted with methanol/DCM (1:9). Product 6 was collected as a white solid (0.260 g, 78%). ¹H NMR (300 MHz, CDCl₃): δ(ppm) 9.27 (s, 1H), 7.28 (d, J=8.7 Hz, 2H), 6.82 (s, 2H), 6.81 (d, J=8.6 Hz, 2H), 6.66-6.57 (overlap, 3), 5.56 (d, J=18.6 Hz, 1H), 5.08 (d, J=10.9 Hz, 1H), 4.52 (s, 4H), 3.92 (dt, J=10.9, 6.4 Hz, 4H), 2.34 (s, 9H), 2.25 (s, 3H), 1.78 (overlap, 4H), 1.50 (overlap, 4H); ¹³C NMR (75 MHz, CDCl₃): δ(ppm) 160.42, 159.57, 158.81, 139.91, 136.69, 136.12, 134.93, 130.43, 130.21, 129.70, 127.20, 125.66, 114.71, 114.49, 111.31, 67.89, 67.82, 52.00, 51.82, 29.03, 28.95, 25.65, 20.84, 18.17, 17.78. HRMS m/z calcd for C₃₄H₄₃O₂N₂ [M⁺] 511.3319, found 511.3319.

### 8. Synthesis of 1-(2,6-dimethyl-4-((6-(4-vinylphenoxy)hexyl)oxy)phenyl)-3-mesityl-2-(trichloromethyl)imidazolidine (7)

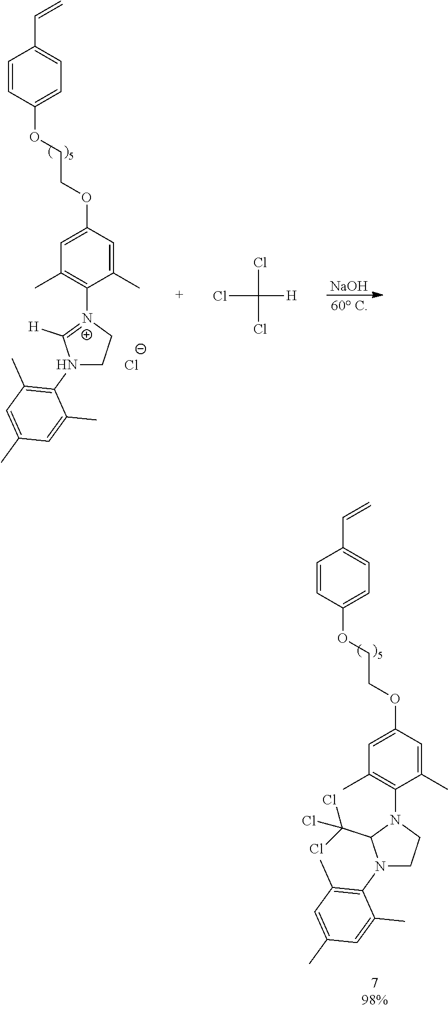

To a Schlenk flask was added freshly powdered sodium hydroxide (0.100 g, 2.71 mmol), which was suspended in dry chloroform (0.0730 mL, 0.910 mmol), followed by dry toluene (8 mL) under nitrogen. The mixture was stirred for 10 min and then 6 (0.100 g, 0.180 mmol) was added to the flask under a stream of nitrogen. The flask was stirred at 60° C. for 2 hr. After the reaction was complete, the solution was cooled to room temperature and filtered through Celite. The filtrate was then concentrated under vacuum to yield 7 as a yellow oil (0.110 g, 98%). ¹H NMR (300 MHz, CDCl₃): δ(ppm) 7.32-7.13 (m, 2H), 6.84-6.81 (m, 4H), 6.68-6.55 (m, 3H), 5.58 (d, J=17.6 Hz, 1H), 5.51 (s, 1H), 5.09 (d, J=10.8 Hz, 1H), 3.941-3.922 (m, 6H), 3.28 (m, 2H), 2.46 (s, 9H), 2.33 (s, 3H), 2.23 (s, 3H), 1.79 (overlap, 4H), 1.51 (overlap, 4H); ¹³C NMR (75 MHz, CDCl₃): δ(ppm) 159.04, 156.41, 141.53, 140.17, 138.16, 137.13, 136.40, 135.58, 134.79, 133.89, 130.06, 129.83, 129.08, 128.27, 127.42, 125.36, 114.64, 111.45, 107.9, 86.42, 67.99, 67.77, 51.99, 51.76, 29.41, 29.30, 25.96, 21.45, 21.38, 20.68, 20.20, 19.92.

### 9. Synthesis of CB6

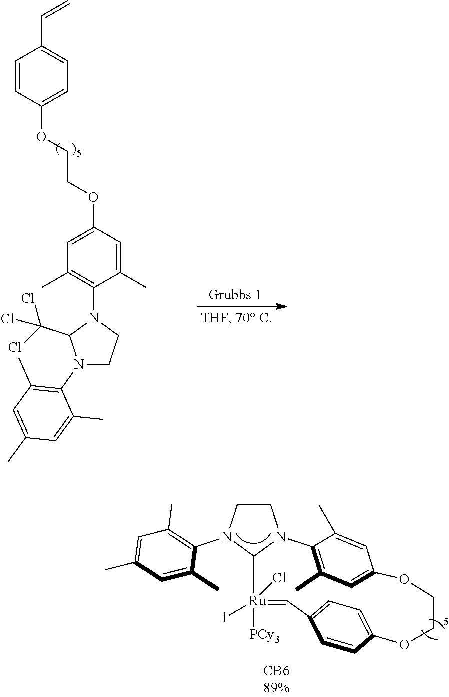

To a dry Schlenk flask equipped with a stir bar was added 7 (0.100 g, 0.159 mmol), Grubbs 1^{st} generation catalyst (0.0650 g, 0.0790 mmol), and dry THF (80 mL) under nitrogen. The resulting solution was stirred at 70° C. for 1 hr (monitored by NMR). After the reaction was complete, the mixture was cooled to room temperature then concentrated under vacuum. The crude mixture was triturated in an ultrasonic bath with diethyl ether/pentane (6:4; 4 mL for every 100 mg of crude mixture). The suspension was then centrifuged at 10° C. (3000 rpm for 20 minutes) followed by decanting the supernatant. This process was repeated 2 more times. The collected tan solid was dried under vacuum to yield CB6 (0.066 g, 89%). ¹H NMR (500 MHz, C₆D₆): δ(ppm) 19.40 (s, 1H) 9.39 (s, 1H), 7.32 (s, 2H), 6.96 (m, 3H), 6.92 (s, 2H), 6.45 (m, 2H), 5.91 (s,1H), 3.99 (s, 1H), 3.65 (s, 1H), 3.42-3.17 (m, 8H), 2.95 (s, 3H), 2.78 (s, 3H), 2.62 (s, 3H), 2.53 (br, 4H), 2.42 (s, 3H), 2.20 (s, 3H), 1.77-1.11 (m, 50H), 0.87 (s, 1H), 0.44 (s, 3H); ¹³C NMR (125 MHz, C₆D₆): δ(ppm) 222.32 (J_{CP}=78.6 Hz), 158.79, 158.51, 147.51, 139.43, 138.40, 138.23, 135.92, 135.37, 133.61, 132.71, 130.17, 117.06, 114.70, 113.68, 109.46, 66.17, 65.04, 52.17, 51.61, 32.16 (J_{CP}=16.0 Hz), 29.86, 29.51, 28.24 (J_{CP}=9.5 Hz), 27.92, 27.17 (J_{CP}=11.3 Hz), 26.64, 26.49, 24.25, 22.43, 21.21, 20.57, 19.54. ³¹P NMR (121 MHz, C₆D₆): δ(ppm) 28.7. HRMS m/z calcd for C₅₁H₇₃O₂N₂Cl₂RuP [M⁺] 948.3825, found 948.3782.

### Example 2

### The Preparation and Characterization of Unsaturated Cyclic 5-Carbon Ruthenium Complex (UC5)

In this example, the preparation and characterization of an unsaturated cyclic 5-carbon ruthenium complex (UC5) is described.

### Synthesis of N-mesitylimidazole (U1)

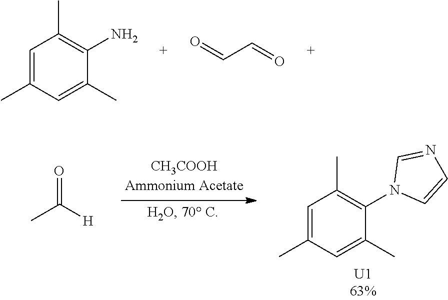

To a round bottom flask equipped a stir bar was added glacial acetic acid (10.0 mL, 175 mmol), aqueous formaldehyde (3.00 mL, 109 mmol) and aqueous glyoxal (4.60 mL, 101 mmol). The resulting mixture was heated to 70° C. A freshly prepared solution of glacial acetic acid (10.0 mL, 175 mmol), ammonium acetate (3.08 g, 40.0 mmol) in water (2 mL), and 2,4,6-trimethylaniline (5.60 mL, 39.9 mmol) were added dropwise to the reaction flask over a period of 35 min. A condenser was attached to the round bottom flask and the solution was stirred for 18 hr at 70° C. The cooled reaction mixture was added dropwise to a stirring solution of NaHCO₃ (29.4 g) in water (300 mL) to precipitate brown solids. The precipitate was filtered, washed with water (3×20 mL), and dried under vacuum. The dried solid was redissolved in minimal methanol, loaded onto a silica column, and eluted with methanol:DCM (1:19). Product U1 was collected as a brown solid (4.67 g, 63%). ¹NMR data is consistent with reported data. ¹H NMR (500 MHz, CDCl₃): δ(ppm) 7.43 (m, 1H), 7.23 (m, 1H), 6.97 (m, 2H), 6.89 (m, 1H), 2.34 (s, 3H), 1.99 (s, 6H).

### Synthesis of 3-(hex-5-en-1-yl)-1-mesityl-1-imidazol-3-ium salt (U2)

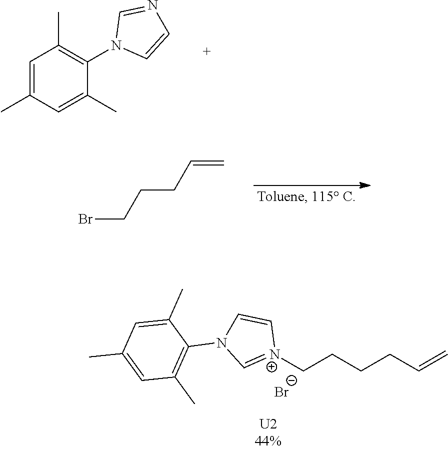

To a round bottom flask equipped with stir bar was added U1 (0.498 g, 2.67 mmol), 6-bromo-1-hexene (0.523 g, 3.21 mmol), and toluene (25 mL). A condenser was attached to the round bottom flask and the solution was heated to 115° C. under nitrogen for 21 hr. The crude reaction mixture was cooled to room temperature and concentrated under vacuum. The solid residue was redissolved in 1 mL of DCM and added slowly to flask containing 20 mL of Et₂O. Immediate brown precipitates were formed. The precipitate was collected and dried under vacuum to yield U2 as a tan solid (0.410 g, 44%). NMR data is consistent with reported data. ¹H NMR (500 MHz, CDCl₃): δ(ppm) 10.51 (s, 1H), 7.68 (t, J=1.6 Hz, 1H), 7.17 (t, J=1.6 Hz, 1H), 6.99 (s, 2H), 5.74 (ddt, J=16.9, 10.2, 6.7 Hz, 1H), 5.09-4.91 (m, 2H), 4.76 (t, J=7.3 Hz, 2H), 2.33 (s, 3H), 2.17-2.09 (m, 2H), 2.07 (s, 6H), 2.05-1.94 (m, 2H), 1.55-1.43 (m, 2H).

### Synthesis of Acyclic Unsaturated 5-Carbon Ruthenium Complex (UA5)

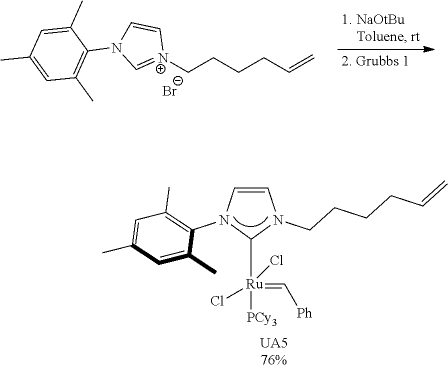

To a dry Schlenk flask equipped with a stir bar was added U2 (0.205 g, 0.587 mmol), solid sodium tert-butoxide (0.0564 g, 0.587 mmol), and dry toluene (5 mL). The reaction mixture was stirred under nitrogen for 2 hr at room temperature. To the same flask, Grubbs 1^{st} generation catalyst (0.241 g, 0.293 mmol) was added under nitrogen and the reaction was stirred for an additional 1.5 hr. The crude solution was loaded onto deactivated silica (treated with Et₃N) and the product was eluted with Et₂O. The collected fractions were dried under vacuum to yield a red/pink solid, UA5 (0.362 g, 76%). NMR data is consistent with reported data. ¹H NMR (500 MHz, CDCl₃): δ(ppm) 19.25 (s, 1H), 7.88 (br, 2H), 7.40 (t, J=7.3 Hz, 1H), 7.14 (d, J=2.0 Hz, 1H), 7.11 (t, J=8.0 Hz, 2H), 6.80 (d, J=1.9 Hz, 1H), 6.29 (br, 2H), 5.82 (ddt, J=17.1, 10.4, 6.7 Hz, 1H), 5.10-4.70 (m, 2H), 4.72 (t, J=7.7 Hz, 2H), 2.50-2.31 (m, 5H), 2.20 (q, J=7.9, 7.4 Hz, 3H), 2.00-1.78 (m, 8H), 1.77-1.55 (overlap, 15H), 1.39-1.23 (m, 6H), 1.23-0.99 (m, 11H).

### Synthesis of Unsaturated Cyclic 5-Carbon Ruthenium Complex (UC5)

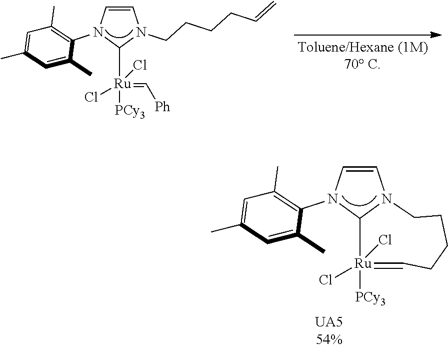

To a dry Schlenk flask equipped with a stir bar was added UA5 (0.170 g, 0.209mmol), degassed toluene (3 mL), and degassed hexane (200 mL). The solution was stirred at 70° C. for 1 hr then cooled to room temperature. The mixture was concentrated under vacuum. The crude residue was triturated with diethyl ether/pentane (1:4; 4 mL for every 100 mg of crude mixture), filtered, and the collected solid was dried under vacuum. The process was repeated 3 times to yield UC5 as a green solid (0.0650 g, 54%). NMR data is consistent with reported data. ¹H NMR (500 MHz, CDCl₃): δ(ppm) 20.25 (dt, J=9.5, 4.9 Hz, 1H), 7.03 (d, J=1.8 Hz, 1H), 7.00 (s, 2H), 6.80 (d, J=1.8 Hz, 1H), 3.58 (t, J=5.8 Hz, 2H), 3.00 (m, 2H), 2.44-2.06 (overlap, 14H), 1.88-1.59 (overlap, 17H), 1.35-1.02 (overlap, 15H).

### Example 3

### The Preparation of Representative Norbornene Monomers BnNb and AcNb

In this example, the preparation of representative norbomnene monomers BnNb and AcNb is described.

### Synthesis of N-benzyl-exo-norbornene-2,3-dicarboximide monomer (BnNb)

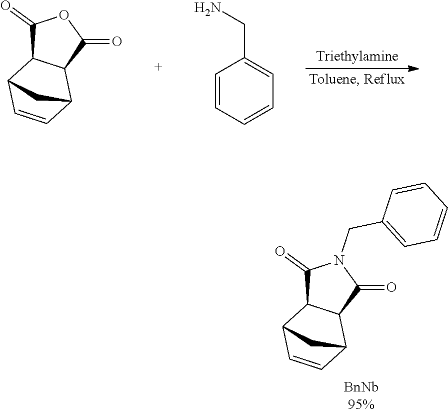 [SMILES: O=C1OC(=O)[C@H]2[C@@H]1[C@@H]1C=C[C@H]2C1 ; NCc1ccccc1 ; O=C1[C@@H]2[C@H](C(=O)N1Cc1ccccc1)[C@H]1C=C[C@@H]2C1]

To a round bottom flask equipped with a stir bar was added cis-5-norbornene-exo-2,3-dicarboxylic anhydride (1.00 g, 6.09 mmol), benzylamine (0.730 mL, 6.70 mmol), triethylamine (0.930 mL, 6.70 mmol), and dry toluene (35 mL). The reaction mixture was stirred at reflux for 20 hr under nitrogen. The reaction mixture was cooled to temperature and extracted with EtOAc (30 mL) and was washed with 10% HCl (2×15 mL), water (3×15 mL), and brine (2×15 mL). The organic phase was collected and dried with sodium sulfate. The filtered solution was concentrated under vacuum to yield a yellow solid. The solid was further purified by crystallization in DCM to obtain BnNb as a white solid (1.47 g, 95%). ¹H NMR (300 MHz, CDCl₃): δ(ppm) 7.44-7.31 (overlap, 5H), 6.33 (s, 2H), 4.68 (s, 2H), 3.31 (s, 2H), 2.74 (s, 2H), 1.47 (d, J=9.9 Hz, 1H), 1.12 (d, J=9.9 Hz, 1H); ¹³C NMR (75 MHz, CDCl₃): δ(ppm) 177.66, 137.95, 135.94, 128.89, 128.65, 127.92, 47.83, 45.33, 42.65, 42.38.

### Synthesis of N-ethyl hydroxyl-exo-norbornene-2,3-dicarboximide (8)

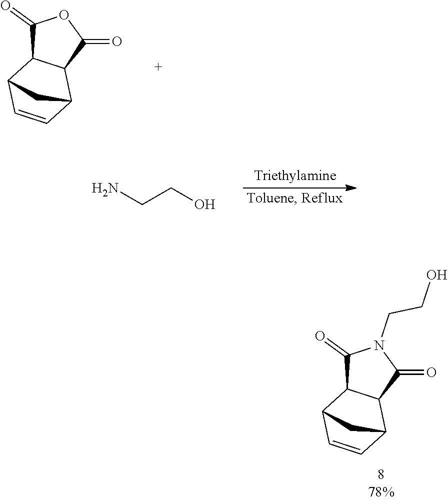

To a round bottom flask equipped with a stir bar was added cis-5-norbornene-exo-2,3-dicarboxylic anhydride (1.00 g, 6.09 mmol), ethanolamine (0.460 mL, 7.61 mmol), triethylamine (0.110 mL, 7.61 mmol), and dry toluene (35 mL). The reaction mixture was stirred at reflux for 12 hr under nitrogen. The reaction mixture was cooled to room temperature, extracted with EtOAc (30 mL), and washed with 10% HCl (15 mL×3), water (15 mL×3) and brine (15 mL×3). The organic phase was collected and dried with sodium sulfate. The filtered solution was concentrated under vacuum to yield 8 as a white solid (1.18 g, 78%). ¹H NMR (300 MHz, CDCl₃): δ(ppm) 6.29 (s, 2H), 3.78 (t, J=5.1 Hz, 2H), 3.70 (t, J=5.3, 2H), 3.29 (s, 2H), 2.72 (s, 2H), 2.13 (br, 1H), 1.52 (d, J=9.9 Hz, 1H), 1.35 (d, J=9.9 Hz, 1H); ¹³C NMR (75 MHz, CDCl₃): δ(ppm) 178.71, 137.84, 60.35, 47.91, 45.29, 42.79, 41.33.

### Synthesis of N-ethyl acetoxy-exo-norbomnene-2,3-dicarboximide (AcNb)

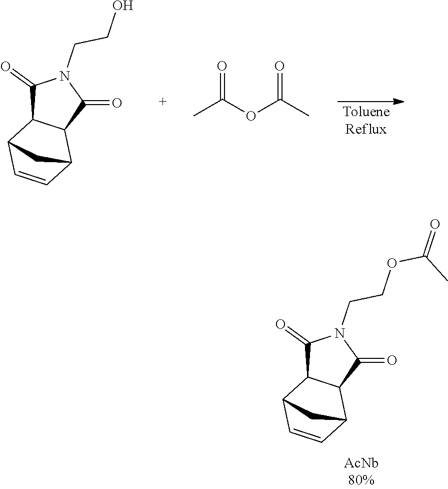

To a round bottom flask equipped with a stir bar was added 8 (1.00 g, 4.82 mmol) and toluene (30 mL). Once dissolved, acetic anhydride (1.37 mL, 14.5 mmol) was added to the flask. The mixture was stirred at reflux for 12 hr. After the reaction was complete, the mixture was cooled to 0° C. and 40 aq wt % methylamine was added dropwise in excess (1 mL) to quench the reaction. The resulting crude mixture was extracted with EtOAc and washed with 10% aq. NaHCO₃ (15 mL×2), water (15 mL×3), and brine (15 mL×2). The organic phase was collected and dried over sodium sulfate. The solution was filtered and concentrated under vacuum. The crude oil was loaded onto a silica column and purified with hexane/EtOAc (2:1) to yield AcNb as a yellow oil (0.962 g, 80%). ¹H NMR (300 MHz, CDCl₃): δ(ppm) 6.29 (s, 2H), 4.22 (t, J=5.1 Hz, 2H), 3.75 (t, J=5.2 Hz, 2H), 3.28 (s, 2H), 2.70 (s, 2H), 1.99 (s, 3H), 1.51 (d, J=9.8 Hz, 1H), 1.30 (d, J=9.8 Hz, 1H); ¹³C NMR (75 MHz, CDCl₃): δ(ppm) 177.81,170.61, 137.82, 60.66, 47.84, 45.27, 42.64, 37.55, 20.68.

### Example 4

### Representative General Procedure for REMP Reactions

In this example, representative procedures for REMP reactions using ruthenium initiators are described. The results for ring-expansion metathesis polymerization reactions using representative monomers (BnNb and AcNb) with cyclic ruthenium-benzylidene initiator (CB6) were compared to UC5 and G2 initiators.

### Representative General Procedure for REMP Reaction with CB6

In a nitrogen-filled glovebox, a 2 mL (8-425) screw-cap vial was charged with monomer AcNb (0.0200 g, 0.0800 mmol) and DCE (0.363 mL). The solution was heated to 55° C., then an aliquot of freshly prepared CB6 stock solution (0.038 mL, 0.01 M CB6 in DCE) was added via micropipette to afford a final monomer concentration of 0.200 M. The vial was sealed with a solid PTFE-lined cap and the polymerization reaction was stirred at 55° C. The reaction vial was cooled to room temperature at the desired reaction time.

The polymer solution was added dropwise into a stirring cold methanol solution. The white precipitate was collected using a centrifuge and dried under vacuum. The solid was redissolved in DCM and reprecipitated in cold methanol two additional times. The resulting white solid was dried under vacuum, dissolved in chloroform, filtered through a 0.2 μm syringe filter, and analyzed by GPC-MALS-IV. Identical procedures were used to prepare polymers from UC5 (55° C. in DCE) and G2 (40° C. in DCM).

### General Procedure for ¹H NMR Spectroscopy Reaction Kinetics Experiments

The target monomer and initiator were brought into a nitrogen-filled glove box. In a dry “threaded-top” NMR tube, the monomer (0.000580 mmol) was dissolved in C₂D₄Cl₂ (0.450 mL) and the NMR tube was sealed with a septum screw cap (8-425). In a separate vial, the desired Ru initiator, CB6, UC5, or G2, (0.0290 mmol) was dissolved in C₂D₄Cl₂ (0.0500 mL) and was fitted with a septum screw cap. The contents of the NMR tube were thermally equilibrated in the NMR probe at 55° C. for 5 min. The tube was removed from the spectrometer and the previously prepared Ru-initiator solution was immediately injected into the NMR tube via microsyringe. The NMR tube was immediately reinserted into the spectrometer for data collection. Reactions were monitored by comparing the integration of the diagnostic cis-alkene monomer peak (ca. 5.8-6.2 ppm) at a given time point to the initial t=0 integration.

The results are summarized in Table 1.

While illustrative embodiments have been illustrated and described, it will be appreciated that various changes can be made therein without departing from the spirit and scope of the invention.

1. A compound of Formula (I): 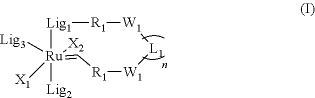
wherein:
X₁ and X₂ are each independently halo;
Lig₁ is an unsaturated N-heterocyclic carbene comprising 1, 2, 3, or 4 N atoms, wherein said unsaturated N-heterocyclic carbene is optionally substituted with 1, 2, or 3 substituents each independently selected from halo, aryl, heteroaryl, C₁₋₆ alkyl, and C₁₋₆ haloalkyl, wherein said aryl, heteroaryl, C₁₋₆ alkyl, and C₁₋₆ haloalkyl are further each optionally substituted with 1, 2, 3, or 4 substituents each independently selected from halo, C₁₋₆ alkyl, and C₁₋₆ haloalkyl; or
Lig₁ is a moiety of Formula (A-1): 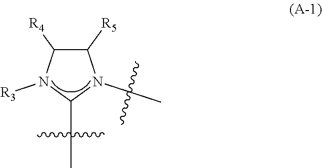
wherein:
R₃ is selected from aryl and heteroaryl, each optionally substituted with 1, 2, 3, or 4 substituents each independently selected from halo, C₁₋₆ alkyl, and C₁₋₆ haloalkyl; and
R₄ and R₅ are each independently selected from H, C₁₋₃ alkyl, halo, C₁₋₃ haloalkyl, aryl, and heteroaryl;
Lig₂ is selected from a phosphine and heteroaryl, each optionally substituted with 1, 2, 3, or 4 substituents each independently selected from halo, C₁₋₆ alkyl, C₁₋₆ haloalkyl, cycloalkyl, and aryl;
Lig₃ is selected from absent and heteroaryl, wherein the heteroaryl is optionally substituted with 1, 2, 3, or 4 substituents each independently selected from halo, C₁₋₆ alkyl, C₁₋₆ haloalkyl, cycloalkyl, and aryl;
R₁ is selected from C₁₋₁₂ alkylene, arylene, and heteroarylene, each optionally substituted with 1, 2, 3, or 4 substituents each independently selected from halo, C₁₋₆ alkyl, and C₁₋₆ haloalkyl;
R₂ is selected from arylene and heteroarylene, each optionally substituted with 1, 2, 3, or 4 substituents each independently selected from halo, C₁₋₆ alkyl, and C₁₋₆ haloalkyl;
W₁ and W₂ are each independently selected from O, C(R₆′)(R₇′), S, and N (R₆″), wherein R₆′, R₇′, and R₆″ are each independently selected from H, halo, C₁₋₆ alkyl, and C₁₋₆ haloalkyl;
L₁, at each occurrence, is selected from C(R₆)(R₇), arylene, and heteroarylene, wherein said R₆ and R₇ are each independently selected from H, halo, C₁₋₃ alkyl, aryl, and heteroaryl; and
wherein said arylene and heteroarylene are each optionally substituted with 1, 2, 3, or 4 substituents each independently selected from halo, C₁₋₆ alkyl, and C₁₋₆ haloalkyl; and
n is an integer selected from 3 to 24.

2-4. (canceled)

5. The compound of claim 1, wherein Lig₁ is a moiety of Formula (A-2) 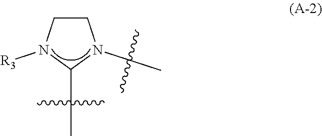
wherein R₃ is selected from aryl and heteroaryl, each optionally substituted with 1, 2, 3, or 4 substituents each independently selected from halo, and C₁₋₆ alkyl.

6. The compound of claim 1, wherein R₃ is aryl optionally substituted with 1, 2, 3, or 4 substituents each independently selected from halo and C₁₋₆ alkyl.

7. The compound of claim 1, wherein R₃ is phenyl optionally substituted with 1, 2, 3, or 4 substituents each independently selected from halo and C₁₋₆ alkyl.

8-10. (canceled)

11. The compound of claim 1, wherein Lig₂ is selected from P(R₈)₃, each R₈ is independently selected from cycloalkyl, heterocycloalkyl; or wherein Lig₂ is pyridyl.

12. (canceled)

13. The compound of claim 1, wherein Lig₃ is heteroaryl, optionally substituted with 1, 2, 3, or 4 substituents each independently selected from halo and C₁₋₆ alkyl.

14. (canceled)

15. The compound of claim 1, wherein Lig₃ is absent.

16. The compound of claim 1, wherein R₁ is selected from C₁₋₁₂ alkylene, arylene, and heteroarylene, each optionally substituted with 1, 2, 3, or 4 substituents each independently selected from halo and C₁₋₆ alkyl.

17-18. (canceled)

19. The compound of claim 1, wherein R₂ is selected from arylene and heteroarylene, each optionally substituted with 1, 2, 3, or 4 substituents each independently selected from halo and C₁₋₆ alkyl.

20-22. (canceled)

23. The compound of claim 1, wherein W₁ and W₂ are each independently selected from O, S, and N(R₆″), wherein and R₆″ is selected from H, halo, and C₁₋₃ alkyl.

24-25. (canceled)

26. The compound of any claim 1, wherein L₁, at each occurrence, is selected from C(R₆)(R₇) and arylene, wherein said R₆ and R₇ are each independently selected from H, halo, and C₁₋₃ alkyl; and wherein said arylene is optionally substituted with 1, 2, 3, or 4 substituents each independently selected from halo and C₁₋₆ alkyl.

27-28. (canceled)

29. The compound of claim 1, wherein n is an integer selected from 5, 6, and 7.

30. (canceled)

31. The compound of claim 1, selected from 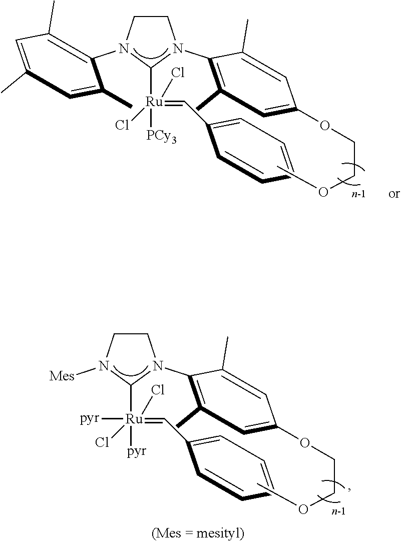
wherein n is 6.

32. The compound of claim 1, 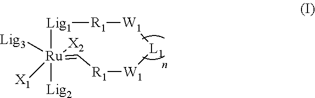
wherein:
X₁ and X₂ are each independently halo;
Lig₁ is a moiety of Formula (A-1): 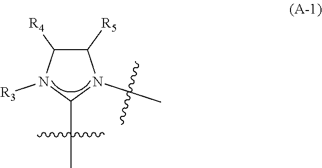
wherein:
R₃ is selected from aryl and heteroaryl, each optionally substituted with 1, 2, 3, or 4 substituents each independently selected from halo, C₁₋₆ alkyl, and C₁₋₆ haloalkyl; and
R₄ and R₅ are each independently selected from H, C₁₋₃ alkyl, halo, and C₁₋₃ haloalkyl;
Lig₂ is selected from a phosphine and heteroaryl, wherein the heteroaryl is optionally substituted with 1, 2, 3, or 4 substituents each independently selected from halo, C₁₋₆ alkyl, and C₁₋₆ haloalkyl;
Lig₃ is selected from absent and heteroaryl, wherein the heteroaryl is optionally substituted with 1, 2, 3, or 4 substituents each independently selected from halo, C₁₋₆ alkyl, and C₁₋₆ haloalkyl;
R₁ is arylene, optionally substituted with 1, 2, 3, or 4 substituents each independently selected from halo, C₁₋₆ alkyl, and C₁₋₆ haloalkyl;
R₂ is arylene, optionally substituted with 1, 2, 3, or 4 substituents each independently selected from halo, C₁₋₆ alkyl, and C₁₋₆ haloalkyl;
W₁ and W₂ are O;
L₁, at each occurrence, is selected from C(R₆)(R₇), wherein said R₆ and R₇ are each independently selected from H, halo, C₁₋₃ alkyl; and
n is an integer selected from 3 to 24.

33. The compound of claim 1, 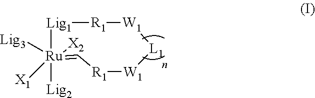
wherein:
X₁ and X₂ are each independently halo;
Lig₁ is a moiety of Formula (A-1): 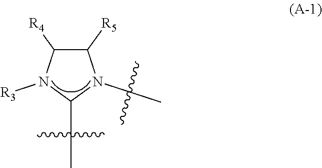
wherein:
R₃ is aryl, each optionally substituted with 1, 2, 3, or 4 substituents each independently selected from C₁₋₆ alkyl; and
R₄ and R₅ are H;
Lig₂ is a phosphine;
Lig₃ is absent;
R₁ is phenylene, optionally substituted with 1 or 2 C₁₋₆ alkyl groups;
R₂ is phenylene;
W₁ and W₂ are O;
L₁, at each occurrence, is CH₂; and
n is an integer selected from 3 to 10.

34. The compound of claim 1, 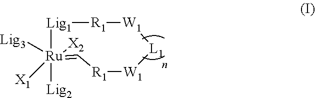
wherein:
X₁ and X₂ are each Cl;
Lig₁ is a moiety of Formula (A-1): 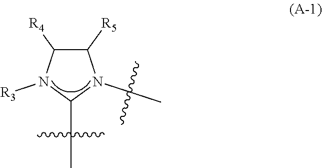
wherein:
R₃ is phenyl, substituted with 1, 2, 3, or 4 substituents each independently selected from C₁₋₆ alkyl; and
R₄ and R₅ are H;
Lig₂ is a phosphine (e.g., trieyelehexylphosphine);
Lig₃ is absent;
R₁ is 1,4-phenylene, optionally substituted with 1 or 2 methyl groups;
R₂ is 1,4-phenylene;
W₁ and W₂ are O;
L₁, at each occurrence, is CH₂; and
n is an integer selected from 3 to 8.

35. The compound of claim 1, 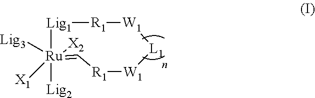
wherein:
X₁ and X₂ are each Cl;
Lig₁ is a moiety of Formula (A-1): 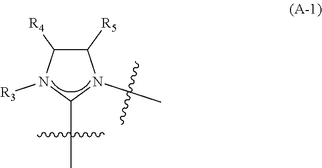
wherein:
R₃ is phenyl, substituted with 1, 2, 3, or 4 substituents each independently selected from C₁₋₆ alkyl; and
R₄ and R₅ are H;
Lig₂ is heteroaryl;
Lig₃ is heteroaryl;
R₁ is 1,4-phenylene, optionally substituted with 1 or 2 methyl groups;
R₂ is 1,4-phenylene;
W₁ and W₂ are O;
L₁, at each occurrence, is CH₂; and
n is an integer selected from 3 to 8.

36. A method of making a cyclic polymer, comprising providing a monomer comprising a double bond, and initiating a ring-expansion metathesis polymerization with a compound of claim 1.

37. The method of claim 36, wherein the monomer comprising a double bond comprises a norbornene-comprising monomer.

38. A method for synthesizing a cyclic polymer via a ring expansion polymerization reaction, comprising combining, to provide a reaction mixture, a cyclic olefin monomer with an effective amount of a compound of claim 1 having a cyclic group of a pre-determined size, whereby the cyclic olefin monomer successively inserts into the cyclic group to increase the size thereof in a stepwise manner without detachment of any linear species from the complex, and following completion of polymerization on the ruthenium compound, the cyclic polymer is released from the compound by an intramolecular chain transfer reaction.
